(19) United States
(12) Patent Application Publication
(10) Pub. No.: US 2026/0203271 A1
(43) Pub. Date: Jul. 16, 2026

(54) GENERATING A TEXTUAL REPRESENTATION OF A TABLE WITHIN A CONNECTED STRUCTURE

(71) Applicant: TUNGSTEN AUTOMATION CORPORATION, Irvine, CA (US)

(72) Inventors: Stephen Michael Thompson, Oceanside, CA (US); Iurii Vymenets, Belgrade (RS)

(21) Appl. No.: 19/565,389

(22) Filed: Mar. 12, 2026

Related U.S. Application Data
(63) Continuation-in-part of application No. 18/965,861, filed on Dec. 2, 2024.
Application No. 18/965,861 is a continuation of application No. 18/763,909, filed on Jul. 3, 2024, now Pat. No. 12,197,412.
Application No. 18/763,909 is a continuation-in-part of application No. 18/080,627, filed on Dec. 13, 2022, now Pat. No. 12,265,516.
Application No. 18/080,627 is a continuation of application No. 17/571,327, filed on Jan. 7, 2022, now Pat. No. 11,977,533.
(60) Provisional application No. 63/170,268, filed on Apr. 2, 2021.
(60) Provisional application No. 63/524,745, filed on Jul. 3, 2023.

(51) Int. Cl. G06F 16/22; G06V 10/70; G06V 30/412; G06V 30/413; G06V 30/414

(52) U.S. Cl. CPC G06F 16/2282; G06V 10/70; G06V 30/412; G06V 30/413; G06V 30/414

(57) ABSTRACT

A computer-implemented method, according to one embodiment, comprises obtaining a hierarchy for a first image of a document, where the hierarchy is a multi-level structured logical tree defining different regions of the first image. The method further includes using the hierarchy to formulate a first connected structure from a first region of the first image, where the formulation of the first connected structure includes: formulating text elements of cells of the first connected structure and assigning meanings to the text elements. The method further includes using the assigned meanings to identify a first subset of the cells of the first connected structure that make up a first table. A computer program product, according to another embodiment, comprises a computer-readable storage medium having program code embodied therewith. The program code is executable by a computing device to cause the computing device to perform the foregoing method.

### RELATED APPLICATIONS

The present application is a continuation in part of U.S. patent application Ser. No. 18/965,861, which is a continuation of U.S. Pat. No. 12,197,412 which claims the benefit of priority to U.S. Provisional Patent Application No. 63/524,745, all of which are herein incorporated by reference. Furthermore, the present application is related to U.S. patent application Ser. No. 18/967,469, which is a continuation of U.S. patent application Ser. No. 18/080,627, which is a continuation of U.S. patent application Ser. No. 17/571,327, which claims the benefit of priority to U.S. Provisional Patent Application No. 63/170,268, all of which are herein incorporated by reference.

### FIELD OF THE INVENTION

The present invention relates to detecting and extracting tables within a connected structure of a document, and more particularly, this invention relates to transforming the information contained within such tables into a textual representation (or equivalent thereof, such as an audio representation).

### BACKGROUND

Images, particularly images of documents, and even more particularly images of “large” and/or “complex” documents like financial reports, medical charts, explanation-of-benefits documents, etc. often contain large volumes of diverse data. The data are diverse with respect to the formatting, content, extent (e.g., single/multi-page), and/or layout, even among similar document types (e.g., the same type of document prepared by different entities and/or according to different conventions, organizational schemes, languages, etc., may exhibit drastically different organization, expression, arrangement, etc. despite depicting the same content or substantially the same content (also referred to herein as “unstructured information”)).

Indeed, there is a long-felt need in the field of document analysis and processing for techniques, especially automated, computerized techniques, for accurately and faithfully processing and analyzing the information represented within images of documents despite the vast volume and extensive diversity with which that information may be presented.

Existing tools such as character recognition of various types (particularly optical character recognition (OCR)), object recognition, etc. for analyzing information present in images have advanced to the point of being capable of detecting, extracting, and analyzing (comprehending) various aspects of images, especially (unstructured) textual information. In addition, advancement in natural language processing techniques, in particular techniques based on large neural networks (often referred to as “deep learning” or “artificial intelligence”), has recently resulted in development of so-called “generative” models such as OpenAI's CHATGPT®, Google's BARD®, etc. that display new capabilities to process textual input and respond to complex prompts, inquiries, and perform unique tasks such as creative composition of “new” material, such as essays, songs, poems, images, etc.

However, these generative models remain under extensive development, and ongoing efforts seek to improve the models' capabilities, particularly regarding table detection within documents, and the appropriate interpretation of the information presented within tables by such models. Traditional table detection is plagued by certain limitations. For example, tables (within a document) do not present a natural language interface (e.g. as with large language model (also referred to herein as “LLM”)). Furthermore, these traditional table detection methods have been unable to take advantage of semantic understanding of words. This has led to longstanding problems distinguishing tables from non-table connected structures. These problems are particularly realized within the analysis of documents in which one or more tables are embedded within a connected structure.

### SUMMARY

A computer-implemented method, according to one embodiment, comprises obtaining a hierarchy for a first image of a document, where the hierarchy is a multi-level structured logical tree defining different regions of the first image. The method further includes using the hierarchy to formulate a first connected structure from a first region of the first image, where the formulation of the first connected structure includes: formulating text elements of cells of the first connected structure and assigning meanings to the text elements. The method further includes using the assigned meanings to identify a first subset of the cells of the first connected structure that make up a first table.

A computer program product, according to another embodiment, comprises a computer-readable storage medium having program code embodied therewith. The program code is executable by a computing device to cause the computing device to perform the foregoing method.

A system, according to another embodiment, comprises a processor, and logic integrated with and/or executable by the processor, the logic being configured to perform the foregoing method.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a connected structure, in accordance with one embodiment.

FIG. 2 is a connected structure that is a grid, in accordance with one embodiment.

FIG. 3A is a table, in accordance with one embodiment.

FIG. 3B is an analyzed image, in accordance with one embodiment.

FIG. 3C is an analyzed image, in accordance with one embodiment.

FIG. 3D is a text fragment of an analyzed image, in accordance with one embodiment.

FIG. 4A is a table, in accordance with one embodiment.

FIG. 4B is a table, in accordance with one embodiment.

FIG. 5 is a connected structure, in accordance with one embodiment.

FIG. 6 is a connected structure, in accordance with one embodiment.

FIG. 7 is a connected structure, in accordance with one embodiment.

FIG. 8 is a connected structure, in accordance with one embodiment.

FIG. 9 is a connected structure, in accordance with one embodiment.

FIG. 10 is a connected structure, in accordance with one embodiment.

FIG. 11 is a connected structure, in accordance with one embodiment.

FIG. 12A is a table, in accordance with one embodiment.

FIG. 12B is a table, in accordance with one embodiment.

FIG. 13 is a collection of tables, in accordance with one embodiment.

FIG. 14 is a table, in accordance with one embodiment.

FIG. 15 is a table, in accordance with one embodiment.

FIG. 16A is a table, in accordance with one embodiment.

FIG. 16B is a table, in accordance with one embodiment.

FIG. 17 is a table, in accordance with one embodiment.

FIG. 18 is a table, in accordance with one embodiment.

FIG. 19 is a table, in accordance with one embodiment.

FIG. 20 is a table, in accordance with one embodiment.

FIG. 21 is a table, in accordance with one embodiment.

FIG. 22 is a table, in accordance with one embodiment.

FIG. 23A is a table, in accordance with one embodiment.

FIG. 23B is a table, in accordance with one embodiment.

FIG. 23C is a table, in accordance with one embodiment.

FIG. 24A is a connected structure, in accordance with one embodiment.

FIG. 24B is a connected structure, in accordance with one embodiment.

FIG. 24C is a connected structure, in accordance with one embodiment.

FIG. 25A is a connected structure, in accordance with one embodiment.

FIG. 25B is a connected structure, in accordance with one embodiment.

FIG. 26 is a connected structure, in accordance with one embodiment.

FIG. 27A is a table, in accordance with one embodiment.

FIG. 27B is a generated textual representation, in accordance with one embodiment.

FIG. 28A is a table, in accordance with one embodiment.

FIG. 28B is a generated textual representation, in accordance with one embodiment.

FIG. 29A is a table, in accordance with one embodiment.

FIG. 29B is a generated textual representation, in accordance with one embodiment.

FIG. 30 is a list, in accordance with one embodiment.

FIG. 31 is a flowchart of a method, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of generating a textual representation of a table of a connected structure and/or related systems and methods.

In one general embodiment, a computer-implemented method comprises obtaining a hierarchy for a first image of a document, where the hierarchy is a multi-level structured logical tree defining different regions of the first image. The method further includes using the hierarchy to formulate a first connected structure from a first region of the first image, where the formulation of the first connected structure includes: formulating text elements of cells of the first connected structure and assigning meanings to the text elements. The method further includes using the assigned meanings to identify a first subset of the cells of the first connected structure that make up a first table.

In another general embodiment, a computer program product comprises a computer-readable storage medium having program code embodied therewith. The program code is executable by a computing device to cause the computing device to perform the foregoing method.

In yet another general embodiment, a system comprises a processor, and logic integrated with and/or executable by the processor, the logic being configured to perform the foregoing method.

As mentioned elsewhere above, images, particularly images of documents, and even more particularly images of “large” and/or “complex” documents like financial reports, medical charts, explanation-of-benefits documents, etc. often contain large volumes of diverse data. The data are diverse with respect to the formatting, content, extent (e.g., single/multi-page), and/or layout, even among similar document types (e.g., the same type of document prepared by different entities and/or according to different conventions, organizational schemes, languages, etc., may exhibit drastically different organization, expression, arrangement, etc. despite depicting the same content or substantially the same content (also referred to herein as “unstructured information”)).

Indeed, there is a long-felt need in the field of document analysis and processing for techniques, especially automated, computerized techniques, for accurately and faithfully processing and analyzing the information represented within images of documents despite the vast volume and extensive diversity with which that information may be presented.

Existing tools such as character recognition of various types (particularly optical character recognition (OCR)), object recognition, etc. for analyzing information present in images have advanced to the point of being capable of detecting, extracting, and analyzing (comprehending) various aspects of images, especially (unstructured) textual information. In addition, advancement in natural language processing techniques, in particular techniques based on large neural networks (often referred to as “deep learning” or “artificial intelligence”), has recently resulted in development of so-called “generative” models such as OpenAI's CHATGPT®, Google's BARD®, etc. that display new capabilities to process textual input and respond to complex prompts, inquiries, and perform unique tasks such as creative composition of “new” material, such as essays, songs, poems, images, etc.

However, these generative models remain under extensive development, and ongoing efforts seek to improve the models' capabilities, particularly regarding table detection within documents. Traditional table detection is plagued by certain limitations. For example, tables (within a document) do not present a natural language interface (e.g. as with large language model (also referred to herein as “LLM”)). Furthermore, these traditional table detection methods have been unable to take advantage of semantic understanding of words. This has led to longstanding problems distinguishing tables from non-table connected structures. These problems are particularly realized within the analysis of documents in which one or more tables are embedded within a connected structure.

Computers and other automated tools are notoriously incapable of achieving comprehension of tables within a connected structure, which often make up a substantial portion of a document. A major focus of machine learning remains on the task of understanding structured information within documents, and requires extensive reliance on a-priori assumptions regarding “ground truths”, annotation and guidance by human “experts”, and training models on vast “training” datasets-which may not be properly representative of the actual truth (e.g., datasets not being fully or appropriately representative of the diverse members of the population the model is designed to understand). Moreover, the resulting model, even if accurate to desired degree, is very limited in scope—the model's performance is limited to processing the type of information upon which it was trained, in which the human is a true “expert”, and the extent to which a-priori assumptions turn out to be true. Accordingly, conventional efforts performed with respect to table analysis within a connected structure of a document are cost-intensive, time-intensive, and of only limited applicability even if an accurate model can be produced in the first instance.

It would therefore be of practical benefit to implement systems, techniques, and computer program products generally configured to facilitate comprehension of information, particularly information contained within an identified table of a connected structure of documents. Techniques of embodiments and approaches described herein enable identification of tables within connected structures, and furthermore, enable generation of a textual representation of the table, e.g., for purposes of refining an output of artificial intelligence (AI) models, e.g., LLMs, that use the textual representation of the table.

### 1. Definitions

Unless otherwise specifically defined herein, all terms are to be given their broadest reasonable interpretation including meanings implied from the specification as well as meanings understood by those skilled in the art and/or as defined in dictionaries, treatises, etc.

Various terms are defined, according to the inventors' meaning thereof, throughout the present specification. The following list of definitions is not to be taken as an exclusive list of terms and corresponding definitions according to the intended meaning thereof, but an exemplary listing of terms and definitions to facilitate the skilled artisan's understanding of the presently disclosed inventive concepts.

It shall be understood that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about”, particularly when used to modify or define a quantitative value or range, shall be understood as encompassing the expressly stated value or range, +10%. For instance, “about 1” shall be understood as encompassing all values in a range from 0.9 to 1.1 (inclusive). Similarly, “a value in a range from about 1 to about 10” shall be understood as encompassing all values in a range from 0.9 to 11 (inclusive). Furthermore, the term “equal” or a determined equality in embodiments and approaches described herein may be defined to be two or more values within one unit of tolerance.

### Connected Structure

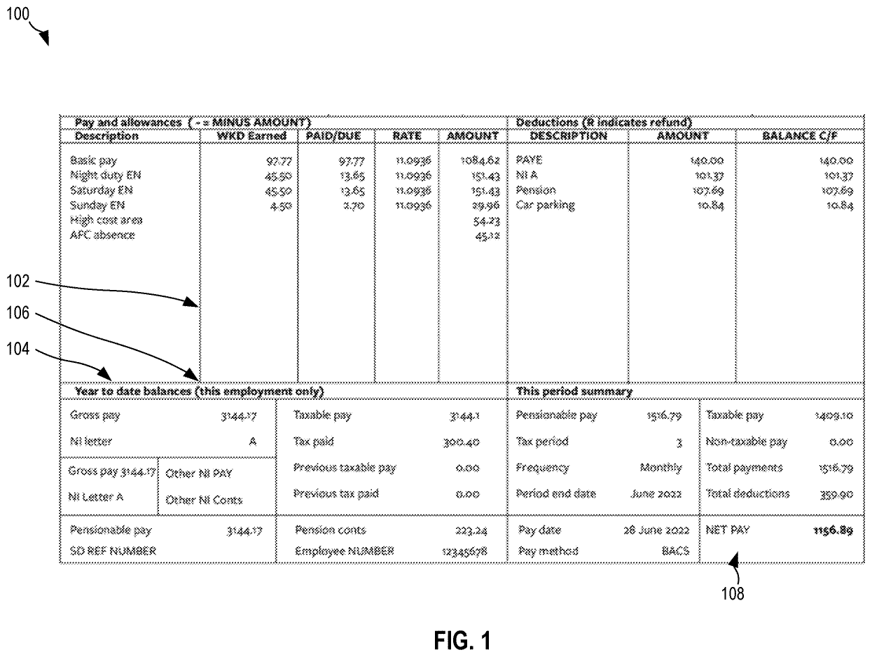

In some preferred approaches, a connected structure may be defined as a region of an image that corresponds to set of horizontal and vertical lines that are connected (i.e. that can be traversed to reach any line from any other line). For purposes of an example, looking to FIG. 1, an exemplary connected structure is illustrated in accordance with one embodiment. However, it should be noted that the connected structure of FIG. 1 is illustrated in accordance with one embodiment which is in no way intended to limit the invention. FIG. 1 depicts a connected structure 100, in accordance with one embodiment. As an option, the present connected structure 100 may be implemented in conjunction with features from any other embodiment listed herein, such as those described with reference to the other FIGS. Of course, however, such connected structure 100 and others presented herein may be used in various applications and/or in permutations which may or may not be specifically described in the illustrative embodiments listed herein. Further, the connected structure 100 presented herein may be used in any desired environment. The connected structure 100 includes a plurality of vertical lines, e.g., see vertical line 102, and a plurality of horizontal lines, e.g., see horizontal line 104. Note that, in some cases, a horizontal line may intersect with a vertical line at an intersection point, e.g., see intersection point 106.

### Key Value Pair

A key value pair may, in some approaches, be defined as an associated combination of a key and a value. More specifically, in one or more of such approaches, the key is a text element (term described in greater detail elsewhere herein), the value is a text element, and the key explains the meaning of the value. For purposes of an example, with reference again to FIG. 1, the connected structure 100 contains a plurality of key-value pairs. For example, in one approach, a first key value pair 108 comprises a key of “NET PAY” and a value of “1156.89” of the first key value pair 108.

### Optical Mark Recognition (OMR)

In some approaches, optical mark recognition is used to describe both the process and the recognized entity (e.g. checkbox, radio button, etc.).

### Text Element

In some approaches, a text element is defined as a single piece of text that is treated as a unit. In some approaches, the text element comprises one word. In contrast, in some other approaches, the text element comprises several relatively closely-spaced, horizontally-consecutive words.

### Text Column

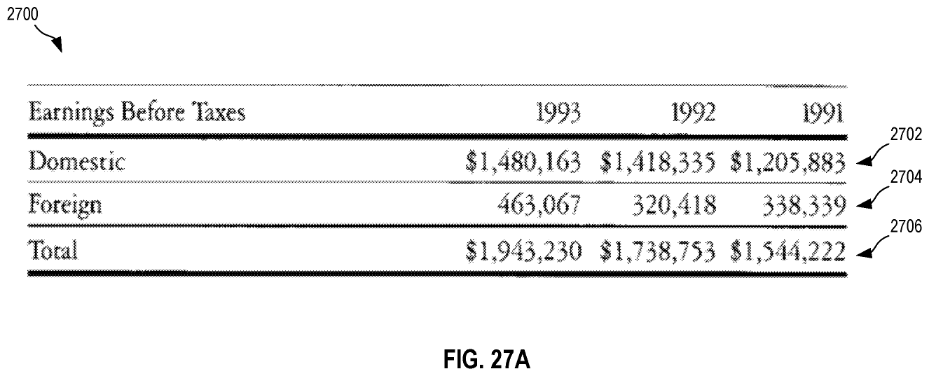

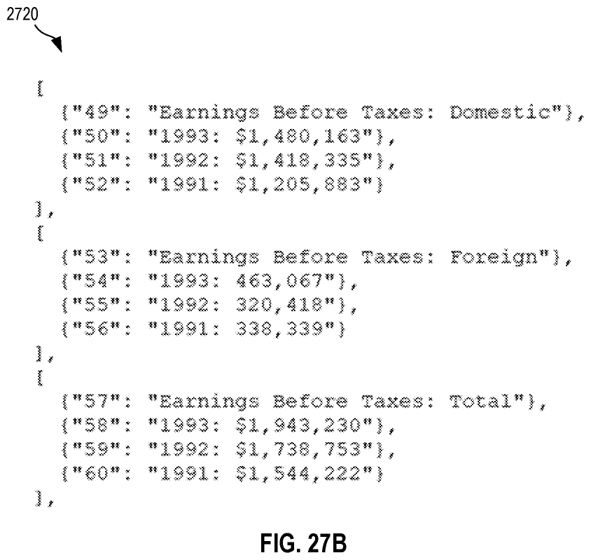

A text column is, in some approaches, defined as two or more text elements that align vertically. Furthermore, text columns are vertically aligned and contiguous groups of text elements of the same type (or a “compatible type”). With respect to a compatible type, various “generic types” may be identified as e.g. number, date, currency, (several others), and the also type “other” has a meaning that is not specifically known. When the types are equal, the text elements are compatible in this regard. Then there are a few exceptions in some approaches where the elements are compatible (i.e. would make sense within the same column) although their types are different. The most prominent of these, in some approaches, is (number, currency). This makes sense in a table column, e.g. see FIG. 27A for an example. Furthermore, in some approaches, an extensive list includes, 1) (number, currency), 2) (identifier, partial numeric), 3) (identifier, other) and 4) (partial numeric, other).

### Table Slice

A table slice is, in some approaches, defined as a vertically oriented portion of a table corresponding to at least a portion of a table column. In one or more of such approaches, a given table slice may be comprised of a body (e.g., typically a text column) and may also often have an associated component such as a header (e.g., typically a text element).

### Vertically Connected

Rectangles (e.g., of text elements) that intersect in the x-coordinate and are contiguous in y-coordinate. This is a transitive property, e.g. if A is connected to B, and B is connected to C, then A is connected to C. The set of such connected rectangles is considered a “connected component”.

### Horizontally-Connected

Rectangles (e.g., of text elements) that intersect in the y-coordinate and are contiguous in x-coordinate. This is a transitive property, e.g. if A is connected to B, and B is connected to C, then A is connected to C. The set of such connected rectangles is considered a “connected component”.

### Vertically Aligned

Rectangles (e.g., of text elements) that are one or more of (left, right, center) aligned in x-coordinate.

### Horizontally Aligned

Rectangles (e.g., of text elements) that are one or more of (top, bottom, center) aligned in y-coordinate.

### Vertically Adjacent

Two cells are vertically adjacent if: (1) the top coordinate (from a front facing view) of one cell equals the bottom coordinate of the other cell, (2) the left coordinate of both cells (from a front facing view) is the same, and (3) the right coordinate (from a front facing view) of both cells is the same. It is important to note that descriptions of (top, left, bottom, right, etc.) with respect to a rectangle refer to a coordinate, not the edge of the shape. With respect to this coordinate, the top is located at point y1, while the bottom is located at point y2, etc. In preferred embodiments, the origin (0,0) is located in the top left of the page, and “y” point numbers increase in value in the downward direction. Meanwhile “x” point numbers increase in value in the right direction.

### Horizontally Adjacent

Two cells are horizontally adjacent if: (1) the left coordinate (from a front facing view) of one cell equals the right coordinate of the other cell, (2) the top coordinate (from a front facing view) of both cells is the same, and (3) the bottom coordinate (from a front facing view) of both cells is the same.

### Vertically Contiguous

Two or more rectangles (e.g. of cells, text elements, etc.) are vertically contiguous if no rectangles of the same type (same type referring to the two or more rectangles both being cells, both including text elements, etc.) reside between any of the rectangles vertically. Although two cells are vertically contiguous if no other cells are between, in some instances, rectangles associated with other entities (e.g., text elements) may exist between the two vertically contiguous cells. An example of vertically contiguous cells is described elsewhere herein, e.g., see FIG. 7.

### Horizontally Contiguous

Two or more rectangles (e.g. of cells, text elements, etc.) are horizontally contiguous if no rectangles of the same type reside between any of the rectangles horizontally.

### Table Column

A column as is commonly known in tables, comprising a header component and a body component. Within a table column, there may be gaps (i.e. empty values).

### Text Line

A text line may be defined by one or more text elements within a cell that are horizontally aligned.

### Cell

A cell is a sub-region within a connected structure that is enclosed on all four cells by graphical lines, and within the enclosure there is not a sub-division by further graphical lines further dividing the sub-region into multiple further sub-regions.

### Grid

A grid is defined as a connected structure or a part of a connected structure that is uniform. “Grids” are characterized by a substantially rectangular shape including X rows and Y columns, a single cell at each integer position of (X, Y), with each cell delineated by surrounding graphical lines. Uniform grids are unique structures that may exist as part of a hierarchy, where a set of adjacent cells form the typical table-like structure wherein each cell is (almost) the same size, aligned such that columns and rows may be formed, etc. Furthermore, “uniform” with respect to a grid means that lines through the grid extend to boundaries of the structure sub-part. By contrast, “non-grids” encompass tables and table-like structures where not all cells are delineated by graphical lines—where there may be some, or no graphical lines present in the table. Moreover, “non-grids” are not limited to rectangular shape, or having a same number of cells in any two given row(s)/column(s). For example, the connected structure depicted in FIG. 7 is a Grid, while the connected structure depicted in FIG. 1 is not a Grid. However, the connected structure depicted in FIG. 1 contains a grid—specifically, the table portion of this connected structure is a Grid.

### Tolerance

The concept of tolerance may, in some preferred approaches, be used to identify coordinates that are effectively equal (e.g. graphical lines that very nearly intersect are considered to intersect). All equalities described herein, unless otherwise stated explicitly, mean tolerantly equal.

### Hierarchy

The term hierarchy mentioned in several embodiments described herein is described in detail in U.S. Pat. No. 12,197,412, which is herein incorporated by reference.

### 2. Formulate Connected Structures

Various approaches below detail a process of formulating connected structures. It may be prefaced that formulation of connected structures may, in some approaches, be an initial step in evaluation of a portion of a document to determine whether a table is included therein, or whether the entire connected structure is a table, e.g., as a common grid. This way, for instances in which a table is identified within a connected structure, a textual representation of the detected table can be generated that faithfully captures the intended meaning of the text within the table (as will be described herein).

In one approach, the formulation of connected structures utilizes a hierarchy that is formulated based on graphical lines. Note that this hierarchy may be made with respect to a portion of a document, e.g., such as an image of one page of the document. A plurality of lines and/or text elements that make up a connected structure may be included in such an image and/or page of the document. For context, this hierarchy may serve as a critical foundation that allows for traversing and analyzing cells and/or other portions of the connected structure.

In some approaches, the hierarchy may be a hierarchical structure for a connected structure of a first image within a document (hierarchy tree) that may be represented as a multi-level structured logical tree (wherein some different portions within the hierarchical structure overlap with one another). Note that, this hierarchical structure overlap more specifically refers to “contained by” when referring to regions (rectangles) on a page.

The multi-level structured logical tree, in some approaches, defines different regions within one or more connected structures of a document page, and each child at the first level of the hierarchy (i.e., direct child of the page) corresponds to the region of a connected structure.

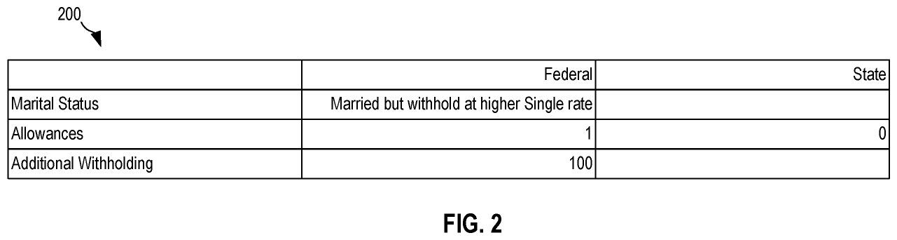

For each child (connected structure) at a first level of the hierarchy (i.e. direct child of the page), the formulation of the connected structures, in some approaches, comprises identifying whether the associated connected structure is a grid. For context, a grid may be defined as connected structures or parts of connected structures that are uniform. For example, FIG. 2 depicts a connected structure that is a grid 200, in accordance with one embodiment. As an option, the present grid 200 may be implemented in conjunction with features from any other embodiment listed herein, such as those described with reference to the other FIGS. Of course, however, such grid 200 and others presented herein may be used in various applications and/or in permutations which may or may not be specifically described in the illustrative embodiments listed herein. Further, the grid 200 presented herein may be used in any desired environment.

In some approaches, grids are detected as tables unless the resulting table would be invalid, which may be determined using a predetermined process. Such a predetermined process, in some approaches, includes determining that the connected structure is an invalid table (and thereby not a grid) in response to a determination that any cell in a top row of the connected structure contains a key or value of a Key-Value Pair. For context, “top row cells” are formulated specially to allow for jagged, hierarchical headers. In another approach, a determination may additionally and/or alternatively be made that the connected structure is an invalid table (not a grid) in response to a determination that any cell in the top row contains OMR. It should be noted that because the operative techniques described herein may be reused (iteratively performed and/or modified to be performed for cells of the connected structure), the “not a grid” determination is not always made with regard to determining ‘grid’ validity, but instead whether the candidate header cells are valid as a header.

In yet another approach, a determination may additionally and/or alternatively be made that the connected structure is an invalid table (not a grid) in response to a determination that any cell in the top row (except a top left cell of the connected structure) is empty (i.e., contains no text element). In yet another approach, a determination may additionally and/or alternatively be made that the connected structure is an invalid table (not a grid) in response to a determination that any cell in top row contains any text element that is inconsistent with table headers. More specifically, in such an approach, it should be noted that text that cannot serve in an “explanatory” role (number, currency, phone, percent, etc.) is inconsistent with table headers in such a determination. For context, and as described elsewhere herein, an explanatory role relates to the fact that some text on its own cannot portray meaning without an association to other surrounding text. For example, the single number “31” does not portray meaning in isolation, while the same number “31” preceded by the text “Age of Applicant:” does convey meaning. Similarly, a column of numbers in isolation does not portray meaning in the absence of an “explanatory” table header (e.g., a header that includes the text “amount” can clarify that the column of numbers are pay rates).

The connected structure may be populated with connected cells. More specifically, analysis of an image may include identifying connected cells of the connected structure. This portion of the predetermined process formulates all of the children of the connected structure (according to the hierarchy described hereinabove) but not including intermediary “container” structures that may exist in the hierarchy mentioned above (e.g. nodes in the hierarchy of type ROW, etc.). Traversal of the hierarchy tree may be stopped for adding (and adding to the connected structure) children that directly contain text to the connected structure. Note that, in some approaches, it is possible that descendants of a given child may also contain text e.g. as in NESTED structures.

### 2.01 Formulate Text Elements

In furtherance of formulating the connected structure, in some approaches, the techniques described herein additionally and/or alternatively include formulating text elements. More specifically, text element(s) of each cell of the connected structure is formulated from text of that is geometrically contained by this child (and also possibly contained by the child's descendants). In some preferred approaches, the text elements are also normalized to determine a meaning of the text elements. Formulation of the text elements, in some approaches, includes using an element analyzer function and/or trained module to replace literal textual values with generic types (e.g. date, dollar, number, etc.). Such a function and/or trained module may also be used to join and/or split textual values (e.g. attach dollar signs to numbers, etc.).

In some approaches, further normalization may be performed to simplify and/or reduce possible types. To clarify, a fundamental objective of such normalization is to determine whether a given text element is “generic” in nature or something that has a known meaning (e.g. and may be interpreted as data within the cell). For context, with respect to whether a given text element is generic in nature or not, it is important to note that some types of text cannot stand alone within a cell or some other portion of a table, but instead must be explained by some other text. For example, the text element “$1000” typically cannot stand on its own because one of ordinary skill in the art upon seeing the text element does not know what the text element describes, e.g., who owes this money, what account the money is located in, whether the money is profit or losses, etc. Some other text that further describes this text element, in one example, is the term “Revenue”. More specifically, one of ordinary skill in the art upon seeing the text element and the additional text understands the meaning that the text “$1000” refers to revenue. Texts such as the “$1000” may be generalized to be type “data”, i.e. something that requires something else to give it meaning. Then these “data” elements become candidates for columns in a table, e.g. when they are aligned and there is an “explaining” text element above (“Revenue”) that can be construed as a column header.

### 2.02 Validate the Connected Structure

In some approaches, the connected structure is potentially validated. This validation, in one or more of such approaches, comprises determining that the connected structure is not of interest (cannot be or contain a table) and therefore is disregard in response to a determination that: 1) the connected structure has less than four text elements that are significant in size (i.e. sufficiently large as determined by a predetermined string size), OR 2) the connected structure has less than two text lines.

### 2.03 Identify Properties of Text Elements

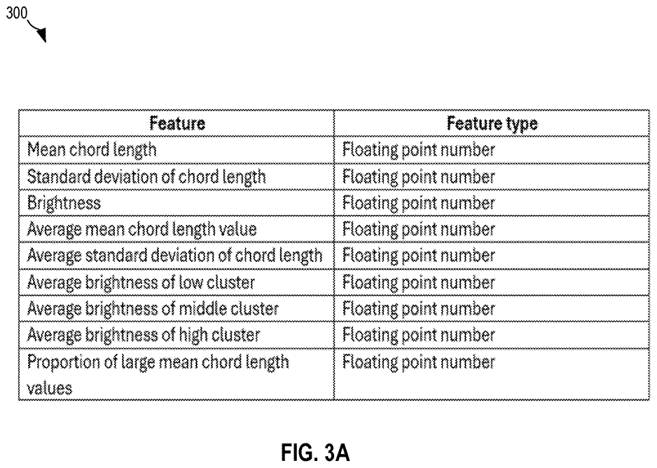

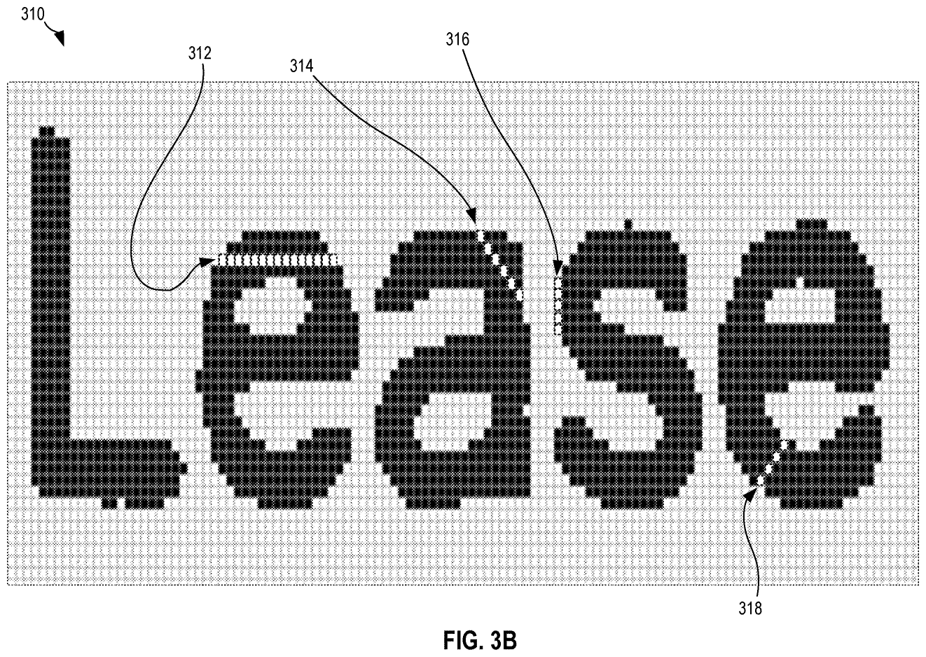

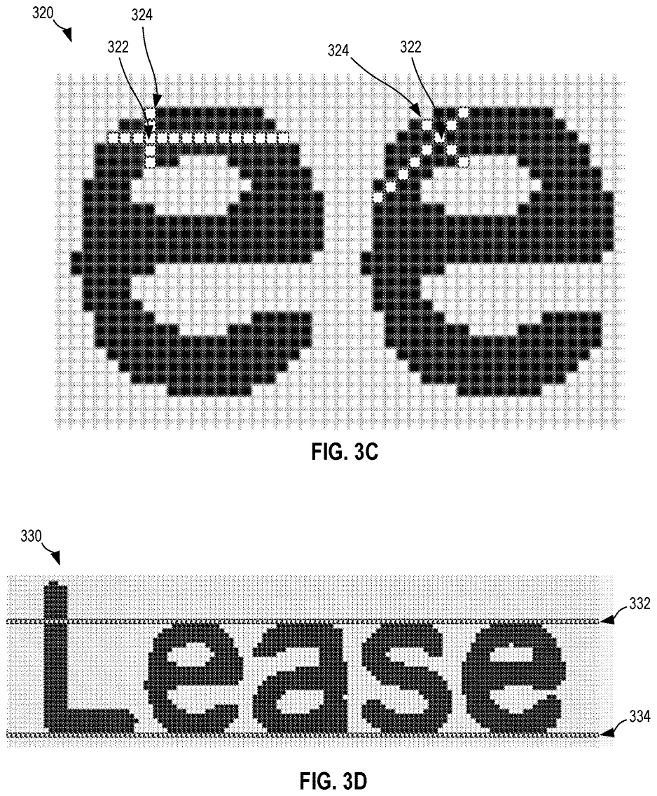

The identification of properties of text elements is, in some approaches, additionally and/or alternatively performed in order to analyze the contents and structure of the connected structure. A first of such properties includes whether the text is underlined. For context, in some approaches, the underlined text property is characterized by a relatively close horizontal line that spans the width of the text element (where the term close horizontal line is defined by the horizontal line being below and within a predetermined threshold distance from the bottom of the text element). Another text property of the text elements may additionally and/or alternatively include whether the text element is a bold font. An algorithm that, according to some preferred approaches, may be used to determine whether a given text element is a bold font is described in greater detail below, e.g., see FIGS. 3A-3D. Looking to FIGS. 3A-3D, exemplary approaches that can be used in the process of determining whether a text element is a bold font are illustrated in accordance with several embodiments, one or more of which may be used to make such a determination. It may be prefaced that, given a document image and optical character recognition (OCR) results (text fragments and their rectangles), these techniques may be used to classify the text fragments into two classes: regular and bold, and provide confidence value for each text fragment. This value indicates a determined degree of confidence with respect to how relatively confident the fragment is bold or regular.

In some approaches, a determination of whether a text fragment is bold or regular (not bold) is based on use of a classifier. For context, in some approaches, the classifier is a machine learning model that takes a batch of feature vectors and provides an output class and confidence value for each feature vector. Operations described herein may, in some approaches, be described to use a classifier with two output classes: “regular” and “bold”. There are many possible implementations of a classifier. One preferred use case example includes a random forest classifier with the “number of trees” parameter set to 100. This type of classifier may be implemented by a plurality of machine learning libraries. Other examples of classifiers include neural networks, support vector machines, and other learn-by-example approaches.

The feature vector that is, in some approaches, submitted to the classifier comprises nine floating point values. These values are based on the concept of an image “chord” which is introduced and used in an original way to calculate these features. One feature vector is generated for each text fragment. The batch supplied to the classifier contains as many feature vectors as there are text fragments.

### 2.04 Features

For each text fragment, a vector of nine features is generated and submitted to the classifier. A preferred table 300 that briefly summarizes and describes these features is illustrated in FIG. 3A. Some other features, e.g., such as the height of the text element in pixels, may, in some approaches, be added to this list, and an extended set of features can be used within the scope of one or more of such approaches.

### 2.05 Image Chord

To calculate one or more of the features, the concept of image chord may be used, in some approaches. For context, an image chord is a sequence of black pixels that form an uninterrupted vertical, horizontal or diagonal line. This concept is only applicable to a binary image where each pixel is either black (text) or white (background). To calculate chords for a grayscale image, the image is first binarized using a binarization algorithm of a type that would become apparent to one of ordinary skill in the art after reading the descriptions herein. In contrast, to calculate chords for a color image, the image in some approaches may be first converted to grayscale and then binarized.

Referring now to FIG. 3B, an analyzed image 310 is determined to include one horizontal chord 312, one vertical chord 316 and two diagonal chords 314 and 318. The image depicted in FIG. 3B contains many additional chords, and these chords are shown in the figure for the purpose of illustration only. In preferred approaches, each foreground pixel is associated with at least one chord, and may be associated with up the four chords (one horizontal chord, one vertical chord, and two diagonal chords).

A chord length is, in some preferred approaches, defined as the Euclidian distance between the chord's endpoints. If the endpoint pixel coordinates are (x1, y1) and (x2, y2), then the chord length “1” may be calculated using Equation (1) below.

$$l = \sqrt{{( {x}_{2} - {x}_{1} )}^{2} + {( {y}_{2} - {y}_{1} )}^{2}} \qquad Equation ( 1 )$$

Note that other definitions, such as Manhattan distance, may additionally and/or alternatively be used within the scope of this approach, depending on the approach.

### 2.06 Shortest Chords

For a given black pixel, there are typically four chords that contain this pixel, e.g., one vertical, one horizontal and two diagonal chords. These chords can have different lengths. For example, the analyzed image 320 illustrated in FIG. 3C includes four chords containing the center pixels 322. Among these chords, there is a shortest one, i.e. the chords 324 that have the minimal length. It is possible that several of these chords have the same minimal length. In this case, one of these chords 324 is selected as the shortest chord for the center pixels. Doing this for each black (i.e. foreground) pixel, a collection of shortest chords is obtained.

### 2.07 Mean Chord Length

Given a text fragment and a rectangle corresponding to it, the mean chord length feature is, in some approaches, defined using a series of predetermined steps. A first of the series of predetermined steps comprises selecting the sub-image of the document image defined by the rectangle of the text fragment. A next of the steps comprises finding the shortest chords on this sub-image, and then a next of the steps comprises calculating the arithmetic mean value of the lengths of these chords (e.g., using Equation (2) below).

$${l}_{mean} = \frac{1}{n} {\sum }_{i = 0}^{n} {l}_{i} \qquad Equation ( 2 )$$

### 2.08 Standard Deviation of Chord Length

A standard deviation of the chord length is, in some approaches, additionally and/or alternatively determined. Given a text fragment and a rectangle corresponding to the text fragment, the standard deviation of chord length feature may be defined using a series of predetermined steps. A first of these predetermined steps comprises selecting the sub-image of the document image defined by the rectangle of the text fragment. Then, the shortest chords on this sub-image are identified. The arithmetic mean value of the lengths of these chords is then calculated using techniques described elsewhere above. The standard deviation (“s”) may be calculated using Equation (3) below.

$$ s = \sqrt{\frac{1}{n - 1} {\sum }_{i = 0}^{n} {( {l}_{i} - {l}_{mean} )}^{2}} \qquad Equation ( 3 )$$

### 2.09 True Rectangle

For a text fragment and a corresponding rectangle, the true rectangle may be defined as a part of the original rectangle having the same width but possibly a smaller height. To obtain this part, the original rectangle is reduced using an algorithm. Hereinbelow, let “n” be the number of characters in the text fragment. Relatively small characters that usually do not occupy the entire line in height are not counted, e.g., such as comma. The true top is defined as the topmost y-coordinate of the original rectangle where the number of black connected components is equal or greater than “n”. If there is no such line, then the true rectangle coincides with the original rectangle. The true bottom is defined as the bottommost line of the original rectangle where the number of black connected components is equal or greater than “n”. The true rectangle is the part of the original rectangle from the true top to the true bottom (inclusive). The text fragment 330 of FIG. 3D depicts the original rectangle and the true rectangle. More specifically, the true top 332 and true bottom 334 are shown. Readers with common knowledge in the art would understand that for text fragments that contain characters such as “j”, “p”, “q”, etc., the true bottom would not coincide with the original bottom.

### 2.10 Brightness

Given a text fragment and a rectangle corresponding to it, in some preferred approaches, the brightness feature may be defined using a predetermined process. In some approaches, this process comprises selecting the sub-image of the page image defined by the rectangle. The sub-image is then reduced to a true rectangle. Next, the process comprises computing the total number of pixels “N” that exist on the reduced sub-image, and then computing the total number of black (foreground) pixels “B” on the reduced sub-image. Finally, in some approaches, the process comprises defining the brightness as a quotient of the variable “B” and the variable “N”, e.g., B/N.

### 2.11 Average Mean Chord Length Value

The average mean chord value feature, in some approaches, is calculated as the arithmetic average of mean chord values of all text fragments, e.g., see Equation (4) below. Note that in Equation (4), the summation is over all text fragments “F”.

$${l}_{avg} = \frac{1}{N} {\sum }_{i = 0}^{N} {l}_{mean} ( {F}_{i} ) \qquad Equation ( 4 )$$

### 2.12 Average Standard Deviation of Chord Length

The average standard deviation of chord length feature is calculated as the arithmetic average of standard deviation of chord length in some approaches. The average standard deviation of chord length feature may, in one or more of such approaches, be calculated using Equation (5) below where the summation is over all text fragments F.

$${s}_{avg} = \frac{1}{N} {\sum }_{i = 0}^{N} s ( {F}_{i} ) \qquad Equation ( 5 )$$

### 2.13 the Three Clusters

In some preferred approaches, all text fragments are divided into three clusters, depending on their mean chord length. For example, the low cluster may contain those text fragments for which Iₘₑₐₙ<I_{avg}. Meanwhile, the middle cluster contains those text fragments for which I_{avg}<=Iₘₑₐₙ<=I_{avg}+s_{avg}/3. The hight cluster contains those text fragments for which Iₘₑₐₙ>I_{avg}+s_{avg}/3. The average brightness of low cluster, average brightness of middle cluster and average brightness of high cluster features are defined as the arithmetic average of brightness over the fragments in the respective cluster. In response to a determination that a cluster is empty, the arithmetic average may be defined to be zero. The constant one-third in these definitions may, in some approaches, be altered within the scope of this approach.

### 2.14 Large Mean Chord Length Values

In some approaches, a determination is made that a text fragment has a large chord length value in response to a determination that Iₘₑₐₙ>I_{avg}+2*s_{avg}/3. Assuming that the variable “L” is the number of such fragments, and the variable “N” is the number of all text fragments, then the feature proportion of large mean chord length values is defined as L/N. The constant two-thirds in this definition may be altered within the scope of this approach.

### 2.15 Training and Running the Machine Learning Model

During development of the techniques described herein, the machine learning model was trained on a large number of real-life documents. To use the trained model in runtime, the trained model was converted to ONNX format and used the ONNX runtime engine to run it at execution time. Other formats and runtime libraries for machine learning models may additionally and/or alternatively be used, depending on the embodiment.

### 2.16 Identify Roles of Connected Cells

With continued reference to the formulation of the connected structures, in some approaches, roles of connected cells are identified to provide context as to how the different cells relate with one another. For example, in some approaches, the roles of connected cells may be optical mark recognition (OMR), e.g., the cell cannot be a table header. Any cell that contains OMR is determined to have the role OMR. In another approach, the roles of connected cells may additionally and/or alternatively be a key value role, e.g., KEY-VALUE. Note that there can be one or many key-value pairs in a given cell, depending on the approach. For a key value roll, in some approaches, all the text elements in the cell need to be determined to be part of a key-value pair, and the key-value pairs need to be determined to be vertically-oriented (since single-line key-value often exist in tables).

In another approach, the roles of connected cells may additionally and/or alternatively be data, e.g., DATA. For context, in some preferred approaches, the role of one or more connected cells may be data in response to a determination that all text elements in the cell are a predetermined data type. Various predetermined data types include, e.g., number, percent, currency, currency_with_units, currency_designator, date, date_range, year, year_range, identifier, partial_numeric, phone number, etc.

### 3 Detecting Tables within Connected Structures

Various approaches below detail a process of detecting tables within connected structures. It may be prefaced that such detection may, in some approaches, be a next step in the evaluation described elsewhere above.

In some approaches, this process includes detecting tables within each connected structure, however, these detected tables are not yet extracted. Instead, this detection is performed to just identify the location(s) of tables, e.g., page of the document, rectangle, etc.

### 3.01 Preparing to Find Tables

In order to detect such tables, in some approaches, various entities are detected in preparation for table detection within the connected structures.

### 3.02 Detecting Text Columns

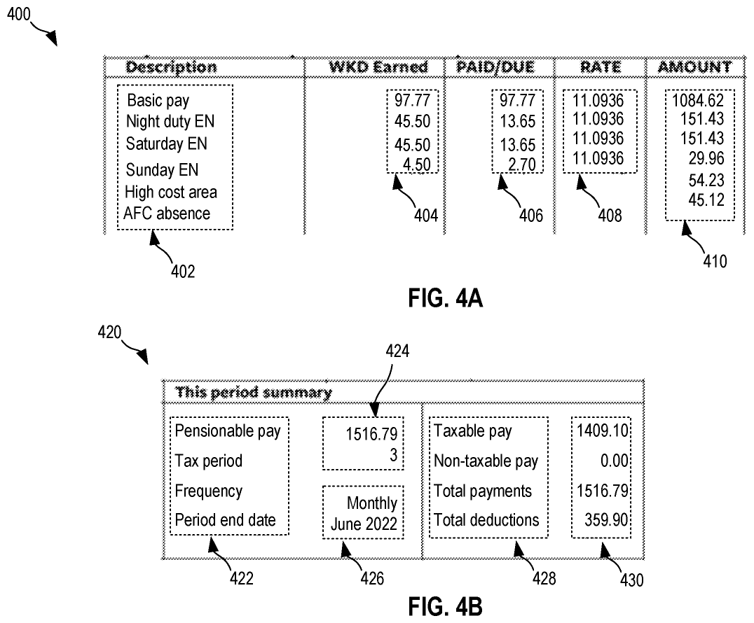

Text columns may additionally and/or alternatively be identified in this process. Text columns are vertically aligned and contiguous groups of text elements of the same type (or a “compatible” type as described elsewhere herein). In tables within connected structures, a text column typically lies within the body component of a table column (i.e. not headers) because the headers are typically a single text line, and hence not a text column as detected herein. FIGS. 4A-4B depict table 400 and connected structure 420 with text columns therein, in accordance with several embodiments. As an option, the present table 400 and connected structure 420 may be implemented in conjunction with features from any other embodiment listed herein, such as those described with reference to the other FIGS. Of course, however, such table 400 and connected structure 420 and others presented herein may be used in various applications and/or in permutations which may or may not be specifically described in the illustrative embodiments listed herein. Further, table 400 and connected structure 420 presented herein may be used in any desired environment.

Referring first to FIG. 4A, table 400 includes five text columns 402, 404, 406, 408 and 410 within the table (text columns surrounded by a dashed rectangle for purposes of viewing clarity).

Referring next to FIG. 4B, connected structure 420 includes five text columns 422, 424, 426, 428 and 430 within the table (text columns surrounded by a dashed rectangle for purposes of viewing clarity). Note that connected structure 420 is not a table and illustrates how text columns may exist in non-table cells of connected structures. Note that the three text columns in the cell on the left (text columns 422, 424, and 426) are determined to be separate due to different types of text elements.

3.03 Detection Algorithm (within Each Cell)

In some approaches, a detection algorithm may be deployed to create vertically-connected components of text elements (i.e. that intersect in the x-axis). Each connected component may be validated as a candidate text column. In some approaches, this validation comprises discarding candidate text columns that contain a key and/or value of a key value pair. This validation may additionally and/or alternatively include enforcement rules. For example, consistent alignment (all Text Elements align in same way-left, right or center) may be enforced, in some approaches. In another approach, consistent text element height (within a predetermined tolerance) may additionally and/or alternatively be enforced. Rules with respect to types of text elements of a candidate text column may also be enforced. For example, types of text elements of a given candidate must be the same or compatible, e.g., primarily in tables: currency, number, other, etc. A few other edge cases may exist, in some approaches.

Further enforcement rules that may additionally and/or alternatively enforced comprise multiple text elements not being allowed to be on the same text line (recall that text elements can consist of multiple words) since this indicates a white-space gap that typically does not exist in table columns. Text elements cannot be underlined in some enforcement rules, unless the data types are considered to be “addable” content (e.g. number or currency, as often occurs for subtotals and totals).

In some approaches, in response to a determination that any of the above criteria (enforcement rules) fail, the connected component is broken at that point (potentially resulting in multiple text columns).

In the produced text columns, in some approaches, the type of each text column may comprise one of either: data (all constituent text elements are type data) or other (otherwise).

### 3.04 Detecting Section Headings

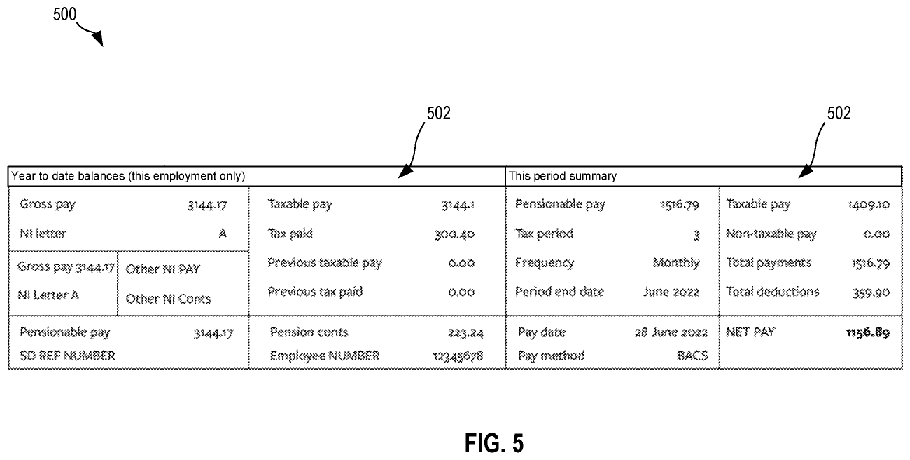

Some cells within connected structures play the role of a section heading. Such cells indicate the proper reading order of cells, as illustrated in FIG. 5. FIG. 5 depicts a connected structure 500, in accordance with one embodiment. As an option, the present connected structure 500 may be implemented in conjunction with features from any other embodiment listed herein, such as those described with reference to the other FIGS. Of course, however, connected structure 500 and others presented herein may be used in various applications and/or in permutations which may or may not be specifically described in the illustrative embodiments listed herein. Further, the connected structure 500 presented herein may be used in any desired environment.

The connected structure 500 illustrates several section headings for purposes of an example. For example, the connected structure 500 includes a first section heading 502 and a second section heading 504.

### 3.05 Detection Algorithm

A trained detection algorithm may be deployed to detect the section headings described above. The detection algorithm may be trained to verify a plurality of conditions. A first of such conditions specifies that a cell must contain a single text element only (potentially comprised of multiple words). Another condition may specify that contents of a cell cannot be a key-value pair, and cannot be in the upper part of the cell (e.g. like a Key in vertical Key-Value pair with empty Value). The contents, in some approaches, must look like a header style, e.g., centered in the x-coordinate and/or all capital letters and/or bold font and/or underlined and/or a shaded cell.

The deployed detection algorithm may additionally and/or alternatively verify that adjacent cell(s) below the candidate section heading cells must have the same left/right boundary as a candidate section heading cell. If there are multiple adjacent cells below (i.e. split cells as in a tree structure), this cell becomes role SECTION_HEADING. If there is only one adjacent cell below, additional criteria may be enforced. This additional criteria, in some approaches, comprises a cell must have multiple text lines that do not form a single vertically-connected group of text elements, i.e., there are multiple vertically-connected groups of text elements geometrically split as in a tree structure (e.g. heading).

### 3.06 Detecting Table Slices

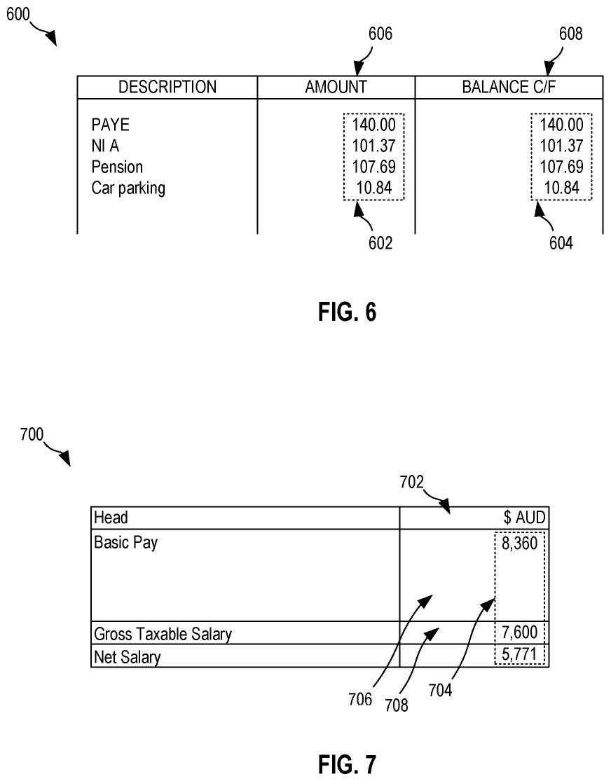

A table slice is a vertical portion of a table corresponding to at least a portion of a table column. Each table slice is comprised of a body component and may (often) also have an associated header component. Examples of table slices are illustrated in FIG. 6. FIG. 6 depicts a connected structure 600, in accordance with one embodiment. As an option, the present connected structure 600 may be implemented in conjunction with features from any other embodiment listed herein, such as those described with reference to the other FIGS. Of course, however, such connected structure 600 and others presented herein may be used in various applications and/or in permutations which may or may not be specifically described in the illustrative embodiments listed herein. Further, the connected structure 600 presented herein may be used in any desired environment.

The connected structure 600 includes two table slices. For example, a first table slice includes a body 602 and header 606, while a second table slice includes a body 604 and header 608. It should be noted that each table slice may or may not correspond to complete table column (e.g. approaches in which there are vertical gaps identified in the table column). There are various possible configurations of table slices that can exist within connected structures. Several of these possibilities are enumerated below (e.g., see cases below which may be detected with specific algorithms also detailed below).

3.07 CASE: Multiple Body Cells with Single Elements

An example of the targeted configuration is shown in FIG. 7. FIG. 7 depicts a connected structure 700, in accordance with one embodiment. As an option, the present connected structure 700 may be implemented in conjunction with features from any other embodiment listed herein, such as those described with reference to the other FIGS. Of course, however, such connected structure 700 and others presented herein may be used in various applications and/or in permutations which may or may not be specifically described in the illustrative embodiments listed herein. Further, the connected structure 700 presented herein may be used in any desired environment.

The connected structure 700 comprises multiple body cells with single elements, e.g., see one table slice with a body 704 and a header 702. All of the body cells are vertically contiguous, e.g., see cell 706 and 708.

In order to detect the case illustrated in FIG. 7, a detection algorithm may be used to identify the body which is defined as multiple vertically adjacent data cells with a single text element of type data (connected components of cells). Furthermore, the detection algorithm is caused to ensure that the text in the cells is of the same or compatible types, the cells are adjacent vertically, the cells have same (left, right) edges, and the text within the cells have consistent alignment (left, right, center). Furthermore, the detection algorithm additionally and/or alternatively must be able to find a header cell above the body of the table slice, e.g., the cell is adjacent above, and includes the same (left, right) edges. For approaches that include a single text line, there must be only one significant (i.e. not very small as determined by a predetermined threshold) text element. In contrast, for approaches that include multiple text lines, the text elements must align in a text column (that was found earlier). If found, a determination is made that a table slice exists, and cell roles are updated, e.g., body cells: TABLE_DATA and header cell: TABLE_HEADER.

3.08 CASE: Single Body Cell with Multiple Elements

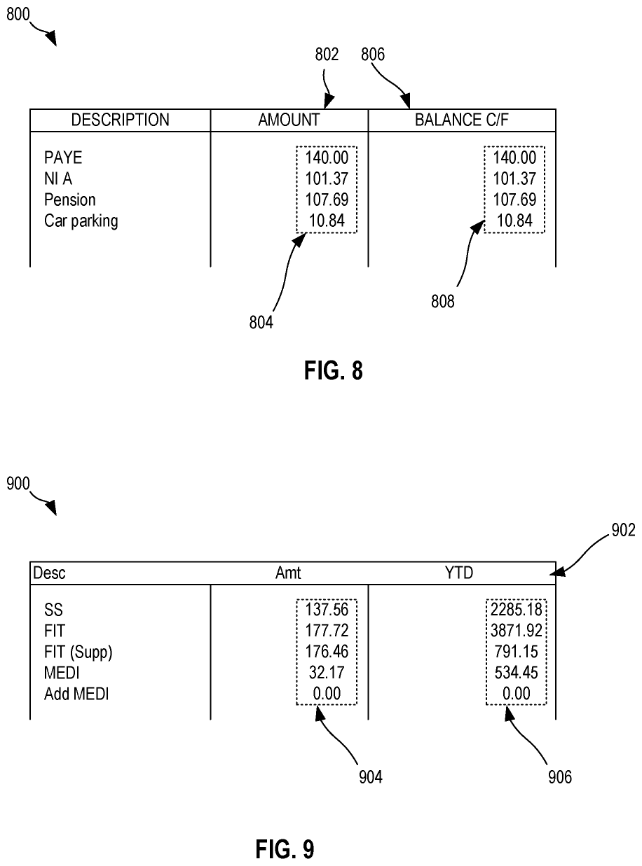

An example of another targeted configuration is shown in FIG. 8. FIG. 8 depicts a connected structure 800, in accordance with one embodiment. As an option, the present connected structure 800 may be implemented in conjunction with features from any other embodiment listed herein, such as those described with reference to the other FIGS. Of course, however, such connected structure 800 and others presented herein may be used in various applications and/or in permutations which may or may not be specifically described in the illustrative embodiments listed herein. Further, the connected structure 800 presented herein may be used in any desired environment.

The connected structure 800 comprises two table slices. For example, the connected structure 800 includes a first table slice that includes a body 804 and header 802, while a second table slice includes a body 808 and header 806.

A detection algorithm may be used to detect these table slices, and more specifically detect the body that is a single cell with multiple text elements, a single text column of type data, and no text elements outside of that text column.

The detection algorithm may try to find a header cell above the body of the table slice (see previous description of detection techniques). In response to such a detection, the detection process ends, and a determination is made that the portion of the connected structure is a table slice. In contrast, in response to a determination that such a detection is not successful, an attempt is made to try to find the header in a different way, i.e., there is no dedicated header cell: the table slice will consist of just the body. An example is shown below of two table slices, e.g., see FIG. 9.

FIG. 9 depicts a connected structure 900, in accordance with one embodiment. As an option, the present connected structure 900 may be implemented in conjunction with features from any other embodiment listed herein, such as those described with reference to the other FIGS. Of course, however, such connected structure 900 and others presented herein may be used in various applications and/or in permutations which may or may not be specifically described in the illustrative embodiments listed herein. Further, the connected structure 900 presented herein may be used in any desired environment.

The attempt made to try to find the header in a different way includes finding the cell above (the previously considered cell) that spans the horizontal width of the body cell, but it is a relatively bigger width. This cell must have an unknown role (i.e. not something that has been diagnosed already by the model). Adjacent body cells left/right from the body cell in question are also identified. These cells may have a same top coordinate as the body cell in question (i.e. this top is the same as cell above bottom). These adjacent body cells must be determined to span the entire width of the cell above (i.e. the algorithm needs to find all of them) and be the same height as the body cell in question. Then the cell above is verified to determine whether the cell satisfies a predetermined header cell criteria. This criteria, in some preferred approaches, comprises column header candidates are the text elements in the cell above and column body candidates are the text columns in the adjacent body cells below. In one optional relatively aggressive enforcement of the criteria, a partial match does not qualify as the predetermined header cell criteria being satisfied. Note that the predetermined header cell criteria is described elsewhere herein and may be used in the present embodiment, e.g., see section 3.14.

The connected structure 900 comprises evaluated bodies 904 and 906 and a single header cell 902 with multiple elements, e.g., see “Desc” and “Amt” and “YTD”. A detection algorithm may be used to detect these table slices, and more specifically detect the body that is a single cell with multiple text elements, a single text column of type data, and no text elements outside of that text column.

In response to a determination that either of the detection algorithms described above are successful, a table slice is identified, and the cell rolls may be updated, e.g., Body Cells: TABLE_DATA and Header Cell (if found): TABLE_HEADER.

3.09 CASE: Multiple Body Cells in Row with Single Elements

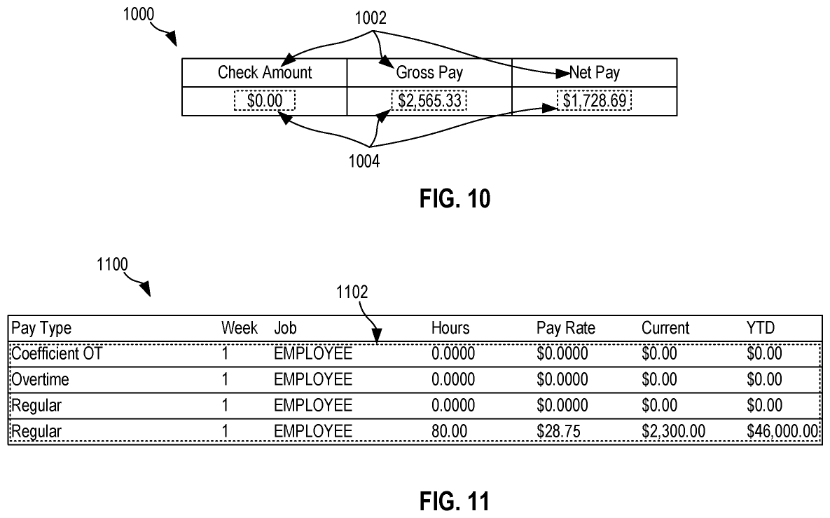

An example of the targeted configuration is shown in FIG. 10. FIG. 10 depicts a connected structure 1000, in accordance with one embodiment. As an option, the present connected structure 1000 may be implemented in conjunction with features from any other embodiment listed herein, such as those described with reference to the other FIGS. Of course, however, such connected structure 1000 and others presented herein may be used in various applications and/or in permutations which may or may not be specifically described in the illustrative embodiments listed herein. Further, the connected structure 1000 presented herein may be used in any desired environment.

The connected structure includes three table slices, e.g., see body components 1004 and header components 1002.

A detection algorithm that may be used to identify the above case may be trained to identify a body that is multiple horizontally adjacent data cells with single text elements of type data (horizontally-connected components of cells). The cells must be determined to be adjacent horizontally, and furthermore the cells need to have the same top/bottom coordinates. For each cell in the body, the detection algorithm must be able to find a header cell above (see previous descriptions herein for detection techniques). If identified, each vertical pair of cells is determined to be a table slice and the cell rolls may be updated, e.g., Body Cells: TABLE_DATA and Header Cells: TABLE_HEADER.

### 3.10 Find Stacks of Cells

In some approaches, the detection of tables within connected structures may additionally and/or alternatively consider a stack, which is a set of vertically adjacent cells that potentially correspond to at least part of the body component of a table. An example of the targeted configuration is shown in FIG. 11. FIG. 11 depicts a connected structure 1100, in accordance with one embodiment. As an option, the present connected structure 1100 may be implemented in conjunction with features from any other embodiment listed herein, such as those described with reference to the other FIGS. Of course, however, such connected structure 1100 and others presented herein may be used in various applications and/or in permutations which may or may not be specifically described in the illustrative embodiments listed herein. Further, the connected structure 1100 presented herein may be used in any desired environment.

The connected structure 1100 includes four stacked cells outlined by the dashed line 1102 for illustrative viewing purposes. A detection algorithm deployed to identify such stacked cells (and/or other stacked cell configurations) may be trained to identify vertically connected cells that have the same left/right edges and that are the same height. These cells must furthermore be unknown or be determined to have a data role. The cells must furthermore be determined to have at least two text elements of type data that form a row in the center of the cell vertically. Text Elements of type data in the row with fewer text elements of type data must also be determined to all align horizontally (left, right, center) with text elements in the row with more text elements of type data. In response to identifying such cells, the cells are determined to be a stack, and all of the cells have a role of stack.

### 3.11 Finding Tables

There are various possible configurations of tables within connected structures. These various configurations may be enumerated and detected using specific algorithms described below.

### 3.12 Finding Tables: From Table Slices

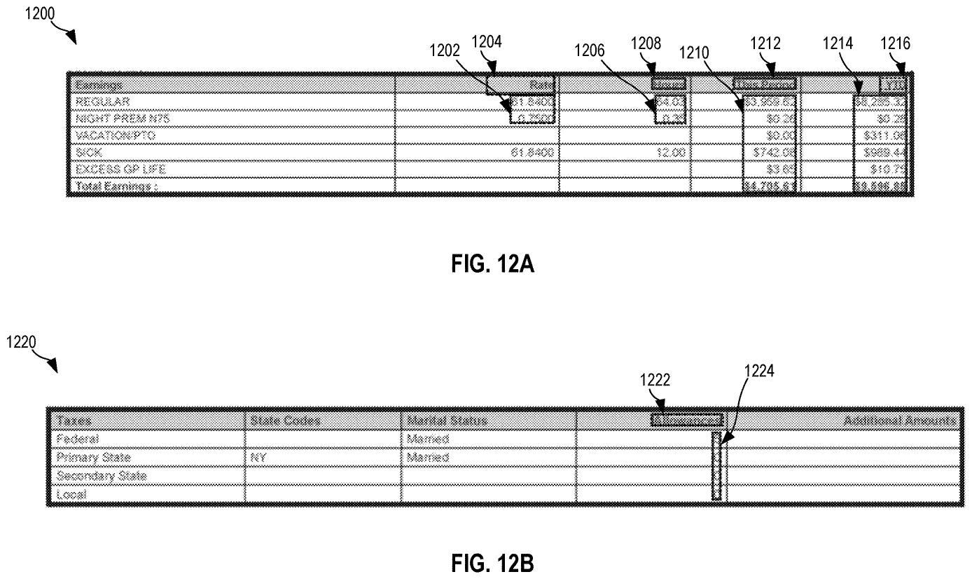

A table slice is a part of table. Accordingly, in some approaches, an attempt is made to find the complete table based upon one or more table slices. FIGS. 12A-12B depict tables 1200 and 1220, in accordance with several embodiments. As an option, the present tables 1200 and 1220 may be implemented in conjunction with features from any other embodiment listed herein, such as those described with reference to the other FIGS. Of course, however, such tables 1200 and 1220 and others presented herein may be used in various applications and/or in permutations which may or may not be specifically described in the illustrative embodiments listed herein. Further, the tables 1200 and 1220 presented herein may be used in any desired environment.

Referring first to FIG. 12A, table 1200 includes four table slices (body and header) shown outlined as (1202, 1204), (1206, 1208), (1210, 1212) and (1214, 1216) to depict the (body component, header component) of each table slice, respectively. Similarly, in FIG. 12B, table 1220 includes a single table slice (body and header) shown outlined by header component 1222 and body component 1224.

A detection algorithm may be used to identify the slices, e.g., such as the table slices of table 1200 in FIG. 12A. The detection algorithm may be performed with respect to each table slice that has a header, and more specifically, for the vertical group of cells in the body part the table slice. The detection algorithm is caused, e.g., instructed, to try to connect to other vertical groups of cells left and right, continuing in each direction until null is returned.

Various operations described below are described for the left direction, but the same operations are preferably performed for the right direction also within the connected structure. For each body cell within a given table slice, an adjacent cell to the left with the same top/bottom is found. The found cells must have a common left edge and be contiguous vertically. A header cell for this new group of cells (which is now an implied table slice) is searched for and connected using techniques previously described elsewhere herein. In response to identification of any implied table slices (in either direction), the detection algorithm connects the cells (body to body) (also body to the original table slice header). In other words, the entire group of cells corresponding to the detected and implied table slices is determined to be a connected component. Alternatively, the full connected component may be found, in some approaches.

In some approaches, a verification process is performed in order to determine whether the candidate header cells are valid. Verification techniques described elsewhere herein may be modified and applied here to perform such a verification (using modification techniques that would become apparent to one of ordinary skill in the art after reading the descriptions herein). In response to a determination that the verification is successful, a detected table is created for the full connected component (e.g. in FIG. 12A and FIG. 12B all cells would be determined to comprise a table). In one exception, it should be realized that, in some use cases, it is possible that tables formed in this way can overlap (in an “L” shape). In response to identifying such an exception has occurred, the new table is joined to the existing overlapping table rather than creating a new one. Cell roles may, in some approaches, be updated, e.g., new cells become role TABLE_PART_IMPLIED.

### 3.13 Finding Tables: Body and Header are Single Cells (Using Text Columns #1)

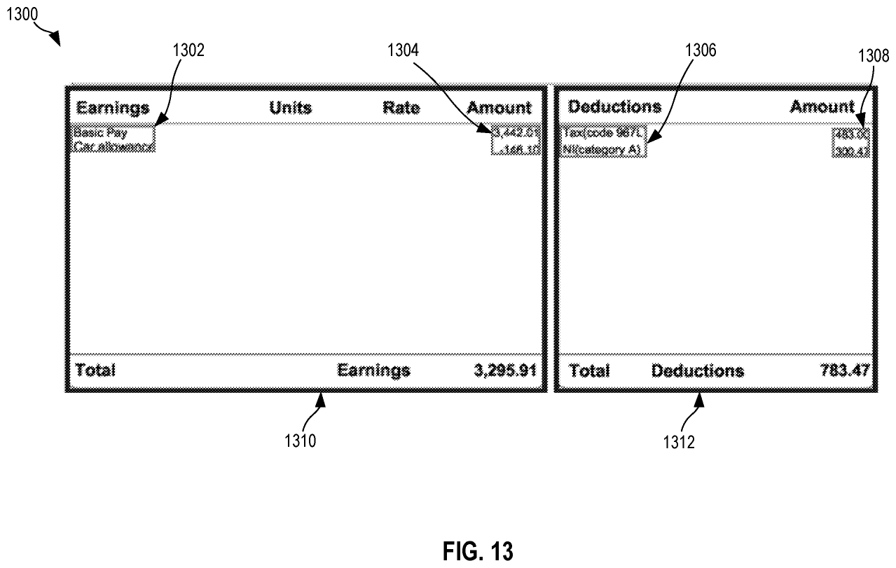

An example of the targeted configuration is shown in FIG. 13. FIG. 13 depicts a collection of tables 1300, in accordance with one embodiment. As an option, the present collection of tables 1300 may be implemented in conjunction with features from any other embodiment listed herein, such as those described with reference to the other FIGS. Of course, however, such collection of tables 1300 and others presented herein may be used in various applications and/or in permutations which may or may not be specifically described in the illustrative embodiments listed herein. Further, the collection of tables 1300 presented herein may be used in any desired environment.

The collection of tables 1300 comprises a first table 1310 and a second table 1312. The tables include a plurality of text columns, e.g., see first text column 1302, second text column 1304, third text column 1306, and fourth text column 1308.

The tables and text columns may be identified using a detection algorithm. The detection algorithm may be configured to determine whether a predetermined condition is met. For example, the condition may specify that one body cell with multiple text lines contains at least two text columns and an unknown role or a data role. The condition may further specify that all text elements within the cell in question are inside of a text column.

Furthermore, there must be an adjacent cell above with an unknown role that satisfies the header cell criteria. The header cell criteria specifies that column header candidates are the text elements in the adjacent cell above. Furthermore, the header cell criteria specifies that column body candidates are the text columns in the cell below. Note that the predetermined header cell criteria is described elsewhere herein and may be used in the present embodiment, e.g., see section 3.14. In one optional relatively aggressive enforcement of the criteria, a partial match does not qualify, e.g., Aggressive (yes), Partial Match (no).

In response to a determination that the criteria above is met, a detected table is created. The cell roles may be updated as well, e.g., Body Cell: TABLE_DATA and Header Cell: TABLE_HEADER. In some approaches, an attempt is made to find and attach a footer cell. Note that techniques for attempting to find and attach a footer cell are described elsewhere herein and may be used in the present embodiment, e.g., see section 3.15.

### 3.14 Header Cell Criteria

In order to determine whether a cell is a column header cell, the header cell criteria considers a set of column header candidates and a set of column body candidates. For example, a column header candidate may be a text element in an adjacent cell above, while a column body candidate may be a text column in an adjacent cell below. The column header candidates must align vertically with the column body candidates. Furthermore, there cannot be multiple intersections. For example, each column body candidate can intersect in x-coordinate at most one column header candidate, and vice versa. Furthermore, every column body candidate must align with one and only one column header candidate. For example, the column body candidate must be determined to either be actually aligned in x-coordinate (left, right, center) with the column header candidate, or one candidate is fully contained in x-coordinate by the other candidate (i.e. body candidate contained in x-coordinate by header candidate, or vice versa), or, for a relatively aggressive option, the intersection length in x-coordinate must be at least half of the smallest width between the header candidate and body candidate. In one exception, the first column body candidate on the left may be allowed to be unmatched (i.e. a leftmost column with no header, as is common in many tables) provided that the first column body candidate is not determined to have a data role. In some approaches, for a partial match option, the header cell criteria is considered successful in response to a determination that at least some column body candidates match a subset of the column header candidates. In response to a determination that the criteria is not satisfied initially, currency symbols may be joined to numbers (e.g. “$” to “134.21”), and the process may be repeated.

### 3.15 Find and Attach a Footer Cell

A footer cell of a connected structure contains totals (e.g., often a sum of an associated column of numbers) or other summary information. A process may be performed to try to find a footer cell associated with a detected tables within a connected structure, in some approaches. The footer cell, in some approaches, must be an adjacent cell below the detected table, must have a single text line, and must have multiple text elements.

In some approaches, each text element of type data in the candidate footer cell must match a text column of type data or text element of type data in the adjacent cell above (i.e. within the detected table). In some approaches, a determination of whether such a condition is met may be based on a text column of type data matching a criteria, e.g., must align and be the same type. Furthermore, in some approaches, for a text element of type data the match criteria may be that the footer cell must align and be the same type and have no text elements in between, i.e. this may be considered as a pseudo-text column comprised of one a single text element.

In response to identifying a footer cell, the table boundary is extended to include this cell and/or the cell role may be updated, e.g., the footer cell becomes the role TABLE-PART-IMPLIED.

### 3.16 Finding Tables: Body is Single Cell, Header is Multiple Cells

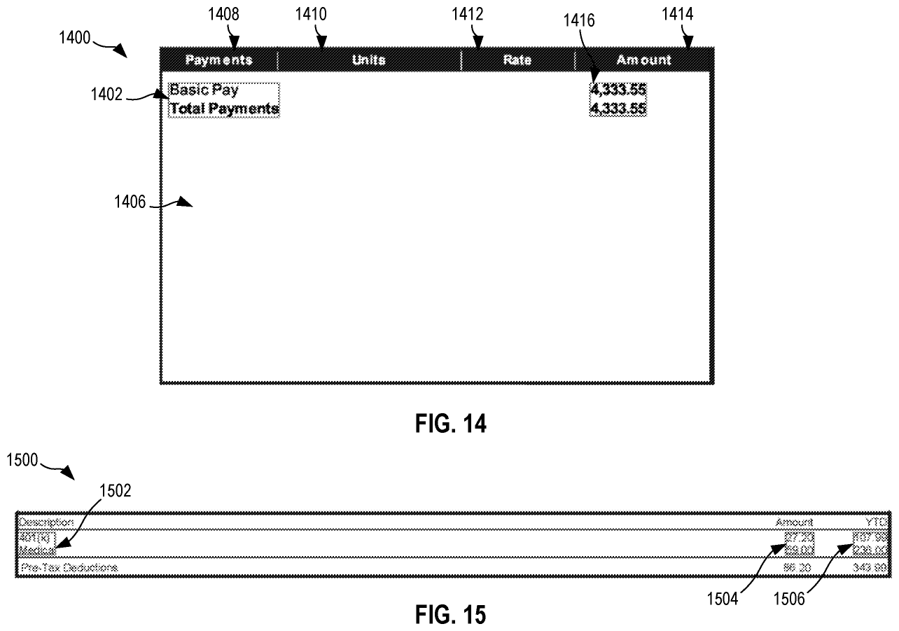

An example of the targeted configuration is shown in FIG. 14. FIG. 14 depicts a table 1400, in accordance with one embodiment. As an option, the present table 1400 may be implemented in conjunction with features from any other embodiment listed herein, such as those described with reference to the other FIGS. Of course, however, such table 1400 and others presented herein may be used in various applications and/or in permutations which may or may not be specifically described in the illustrative embodiments listed herein. Further, the table 1400 presented herein may be used in any desired environment.

The table 1400 comprises a plurality of text columns, e.g., see first text column 1402 and second text column 1416. Furthermore, table 1400 comprises four header cells (first header cell 1408, second header cell 1410, third header cell 1412, and fourth header cell 1414,) and one body cell 1406 that contains the two text columns.

A detection algorithm may be deployed to find tables similar to the table shown in FIG. 14. The detection algorithm is trained to identify that there must be one body cell of unknown or data role with multiple text lines containing at least two text columns. Furthermore, conditions that the detection algorithm searches for include all text elements of the candidate body cell being inside of a text column, with adjacent cells above. These conditions further comprise a same left/right boundary between the candidate body cell and the adjacent cells above, the bottom coordinate of the adjacent cells above touching the top coordinate of the candidate body cell, all adjacent cells above have the same top line, and the adjacent cells above being contiguous (no gaps). The horizontal extent of every text column must be contained by and intersect one and only one header cell. If found by the detection algorithm, a detected table is created. The cell rolls may be updated, e.g., Body Cell: TABLE_DATA and Header Cells: TABLE_HEADER. An attempt may be made to find and attach a footer cell to the table. Note that techniques for attempting to find and attach a footer cell are described elsewhere herein and may be used in the present embodiment, e.g., see section 3.15.

### 3.17 Finding Tables: Body is Row of Multiple Cells, Header is Single Cell

An example of the targeted configuration is shown in FIG. 15. FIG. 15 depicts a table 1500, in accordance with one embodiment. As an option, the present table 1500 may be implemented in conjunction with features from any other embodiment listed herein, such as those described with reference to the other FIGS. Of course, however, such table 1500 and others presented herein may be used in various applications and/or in permutations which may or may not be specifically described in the illustrative embodiments listed herein. Further, the table 1500 presented herein may be used in any desired environment.

The table 1500 comprises a plurality of text columns, e.g., see first text column 1502, second text column 1504 and third text column 1506.

In some approaches, a trained detection algorithm is used to identify a table (such as table 1500) from a connected structure. In such approaches, the connected structure contains at least three cells, all of which span the entire width of the connected structure. Furthermore, the detection algorithm verifies that there are at least two text columns of type data in the connected structure, and there is only one vertical extent of the text columns of type data (i.e. no gaps vertically). In some approaches, the process of identifying the table further includes creating horizontally-connected components of text columns as there can be only one such connected component. Processing resources may additionally and/or alternatively be expended to try to identify the cell that is the header, moving upward from the top of the connected component of text columns of type data. A cell of the evaluated connected structure must be unknown role with a single text line comprised of multiple text elements. Furthermore, the horizontal extent of each text column of type data must intersect one and only one text element in the candidate header cell. The candidate header text element, in preferred approaches, must be the other type and must overlap by 50% of the smallest width between text column of type data and candidate header text element. Provided that the above conditions are verified by the detection algorithm, a determination is made that a table has been detected. The table is the data cells and the header cell and any cell that intersects that joined rectangle (e.g., in other words there may be gaps). In response to such an identification, cell rolls within the table may be updated, e.g., Body Cell: TABLE_DATA and Header Cell: TABLE_HEADER and Other Cells: TABLE_PART_IMPLIED).

### 3.18 Finding Tables: Body and Header are Single Cells (One Data Row Only)

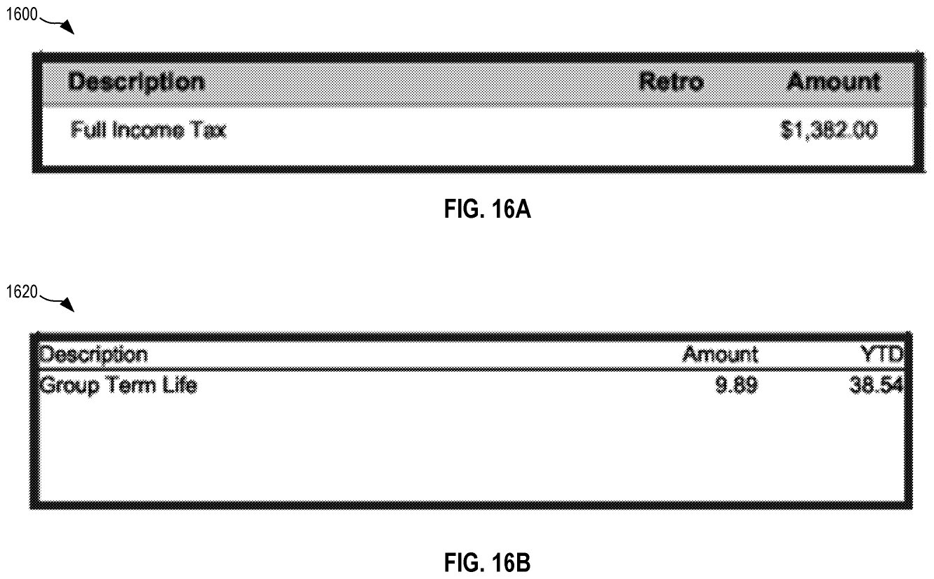

Examples of the targeted configuration are shown in FIGS. 16A-16B. FIGS. 16A-16B depict tables 1600 and 1620, in accordance with several embodiments. As an option, the present tables 1600 and 1620 may be implemented in conjunction with features from any other embodiment listed herein, such as those described with reference to the other FIGS. Of course, however, such tables 1600 and 1620 and others presented herein may be used in various applications and/or in permutations which may or may not be specifically described in the illustrative embodiments listed herein. Further, the tables 1600 and 1620 presented herein may be used in any desired environment.

A detection algorithm is, in some approaches, trained to identify tables with a body and header that are single cells (as illustrated in FIGS. 16A-16B). A connected structure may be evaluated by the detection algorithm to identify a single-line cell with unknown role, in some approaches. In such approaches, at least one of the text elements must be data, while none can be key-value. In contrast, there may additionally and/or alternatively be an adjacent cell above with unknown role. A verification process may then be performed to verify that the adjacent cell above satisfies a header cell criteria. The header cell criteria, in some approaches, specifies that the column header candidates are the text elements in the adjacent cell above, and the column body candidates are the text elements in the cell below. Note that the predetermined header cell criteria is described elsewhere herein and may be used in the present embodiment, e.g., see section 3.14. In one optional relatively aggressive enforcement of the criteria, a partial match does not qualify, e.g., Aggressive (yes), Partial Match (no). In response to a determination that the criteria above are met, a detected table is created, the cell rolls may be updated, e.g., Body Cell: TABLE_DATA and Header Cell: TABLE_HEADER, and an attempt may be made to find and attach a footer cell. Note that techniques for attempting to find and attach a footer cell are described elsewhere herein and may be used in the present embodiment, e.g., see section 3.15.

### 3.19 Finding Tables: Body is Stack, Header is Single Cell

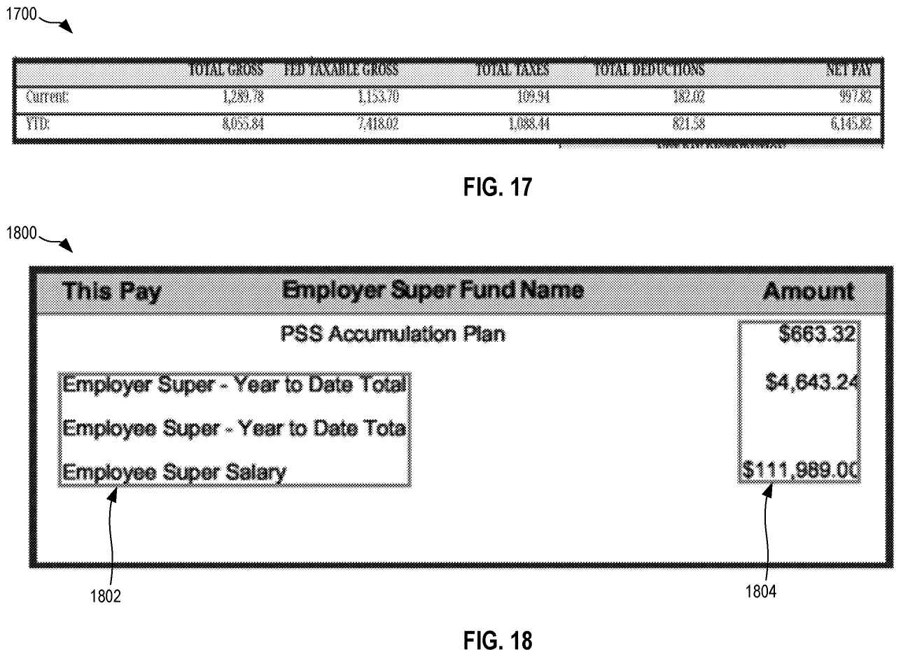

An example of the targeted configuration is shown in FIG. 17. FIG. 17 depicts a table 1700, in accordance with one embodiment. As an option, the present table 1700 may be implemented in conjunction with features from any other embodiment listed herein, such as those described with reference to the other FIGS. Of course, however, such table 1700 and others presented herein may be used in various applications and/or in permutations which may or may not be specifically described in the illustrative embodiments listed herein. Further, the table 1700 presented herein may be used in any desired environment.

A detection algorithm may be trained and deployed to identify a connected structure that includes tables with a body that is a stack and has a header that is a single cell. For example, given a stack the detection algorithm may be trained to verify that there is an adjacent unknown cell above. Furthermore, the cell height is same as height of cells in the stack. The algorithm may then verify that the adjacent cell above satisfies a predetermined header cell criteria where column header candidates are the text elements in the adjacent cell above and column body candidates are the text elements in the first (topmost) stack cell below. Note that the predetermined header cell criteria is described elsewhere herein and may be used in the present embodiment, e.g., see section 3.14. In one optional relatively aggressive enforcement of the identification, a partial match does not qualify, e.g., Aggressive (yes), Partial Match (no). In response to a determination that the algorithm finds such a table, a table is created, and cell rolls may be updated, e.g., Body Cell: TABLE_DATA and Header Cell: TABLE_HEADER.

### 3.20 Finding Tables: Body and Header are Single Cells (Using Text Columns #2)

An example of the targeted configuration is shown in FIG. 18. FIG. 18 depicts a table 1800, in accordance with one embodiment. As an option, the present table 1800 may be implemented in conjunction with features from any other embodiment listed herein, such as those described with reference to the other FIGS. Of course, however, such table 1800 and others presented herein may be used in various applications and/or in permutations which may or may not be specifically described in the illustrative embodiments listed herein. Further, the table 1800 presented herein may be used in any desired environment.

The table 1800 includes a plurality of text columns, e.g., see first text column 1802 and second text column 1804. A detection algorithm may be trained and deployed to identify a connected structure that includes a table with a body and header that are single cells. For example, the algorithm may be trained to analyze a connected structure for each multi-line cell with unknown or data role that contains at least one text column of type data that goes all the way to the top (within one average text height). Furthermore, the cell must have an adjacent cell above with unknown role.

A verification may next be performed to verify that the adjacent cell described above satisfies a header cell criteria where column header candidates are the text elements in the adjacent cell above and column body candidates are the text columns in the cell below. Note that the predetermined header cell criteria is described elsewhere herein and may be used in the present embodiment, e.g., see section 3.14. In one optional relatively aggressive enforcement of the identification, a partial match does qualify, e.g., Aggressive (yes), Partial Match (yes).

In response to a determination that the above verification is met, the detected table is created, and cell rolls therein may be updated accordingly, e.g., Body Cell: TABLE_DATA and Header Cell: TABLE_HEADER. Moreover, an attempt to identify and attach a footer cell may be performed, e.g., using techniques described elsewhere herein.

### 3.21 Finding Tables: Body and Header are Single Cells (Using Text Columns #3)

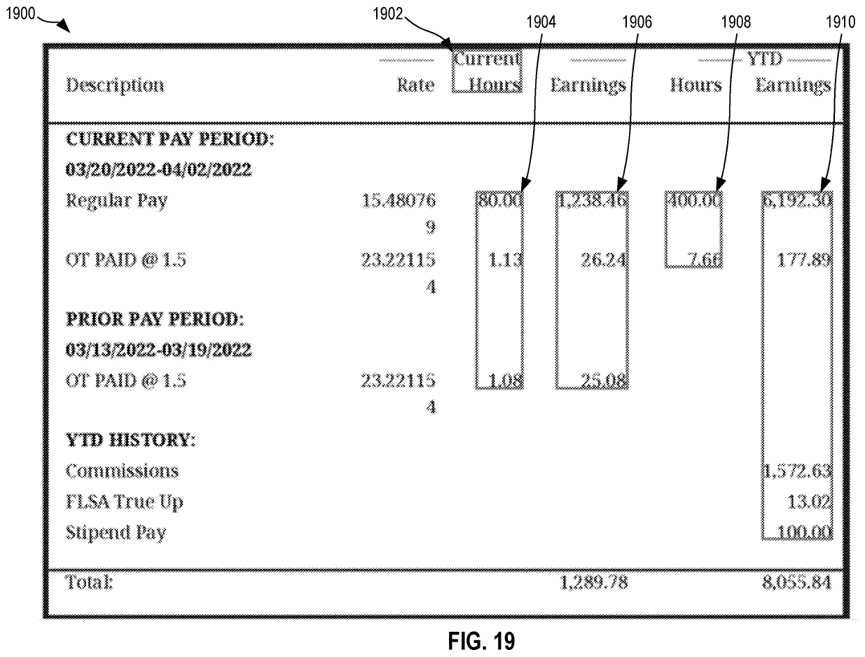

An example of the targeted configuration is shown in FIG. 19. FIG. 19 depicts a table 1900, in accordance with one embodiment. As an option, the present table 1900 may be implemented in conjunction with features from any other embodiment listed herein, such as those described with reference to the other FIGS. Of course, however, such table 1900 and others presented herein may be used in various applications and/or in permutations which may or may not be specifically described in the illustrative embodiments listed herein. Further, the table 1900 presented herein may be used in any desired environment.

The table 1900 includes a plurality of text columns, e.g., see first text column 1902, second text column 1904, third text column 1906, fourth text column 1908, and fifth text column 1910. A detection algorithm, in some approaches, may be trained and deployed to identify a connected structure that includes a table with a body and header are single cells as shown in FIG. 19. The detection algorithm may be deployed to identify for each multi-line cell with unknown or data role that contains at least two text columns of type data with no text elements above them (i.e. no candidate headers reside within the cell), and at least two such text columns must constitute an “adjacent pair”. It should be noted that to be considered an adjacent pair there cannot be any text elements in between (e.g. that might serve to “explain” the data in the text column(s) on the right), and the text column with fewest text elements must form rows for each such text element within the other text column(s). If there is one or more adjacent cells above, a determination may be made that the header(s) have been found, i.e., based on the premise that this cell is needed to “explain” the text columns of type data. In response to a determination that the above condition is identified by the detection algorithm, the detected table is created, and cell rolls therein may be updated accordingly, e.g., Body Cell: TABLE_DATA and Header Cell: TABLE_HEADER. An attempt, in some approaches, may additionally be made to find and attach a footer cell to the created table. Note that techniques for attempting to find and attach a footer cell are described elsewhere herein and may be used in the present embodiment, e.g., see section 3.15.

3.22 Finding Tables: Body and Header in Same Cell (Text Columns with Underlined Headers)

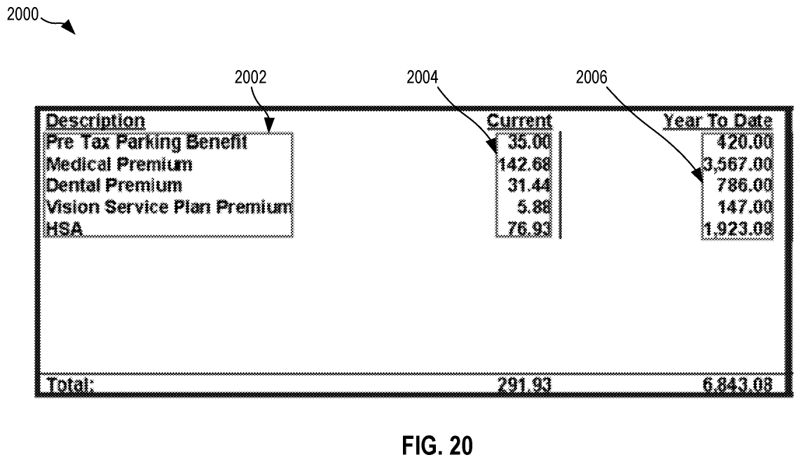

An example of the targeted configuration is shown in FIG. 20. FIG. 20 depicts a table 2000, in accordance with one embodiment. As an option, the present table 2000 may be implemented in conjunction with features from any other embodiment listed herein, such as those described with reference to the other FIGS. Of course, however, such table 2000 and others presented herein may be used in various applications and/or in permutations which may or may not be specifically described in the illustrative embodiments listed herein. Further, the table 2000 presented herein may be used in any desired environment.

The table 2000 includes a plurality of text columns, e.g., see first text column 2002, second text column 2004, and third text column 2006. A detection algorithm, in some approaches, may be trained and deployed to identify a connected structure that includes a table with a body and header in the same cell as shown in FIG. 20. The detection algorithm may be deployed to identify a cell with an unknown role, e.g., the cell must be unknown role. The detection algorithm then finds the number of text columns that are “labelled” with an underlined text element (presumed header). There is an underlined text element (presumed header) above the text column that significantly intersects horizontally, and there are no other text elements in the “header rectangle” (above the text column and below or to the side of the underlined text element). A record is created (e.g., log) that details whether the text column is data or other (role). In response to a determination that the evaluated connected structure (or portion thereof) includes one labeled text column of type data, this is sufficient. In response to a determination that one labeled text column of type data is not present (otherwise case) at least two labeled TEXT COLUMN OF TYPE OTHER, and their headers (underlined texts) must align. If found, a detected table is created, e.g., see FIG. 20, and cell rolls therein may be updated, e.g., TABLE_PART_IMPLIED. In some approaches, an attempt to find and attach a footer cell may be made. Note that techniques for attempting to find and attach a footer cell are described elsewhere herein and may be used in the present embodiment, e.g., see section 3.15.

3.23 Finding Tables: Body and Header in Same Cell (Single Row with Underlined Headers)

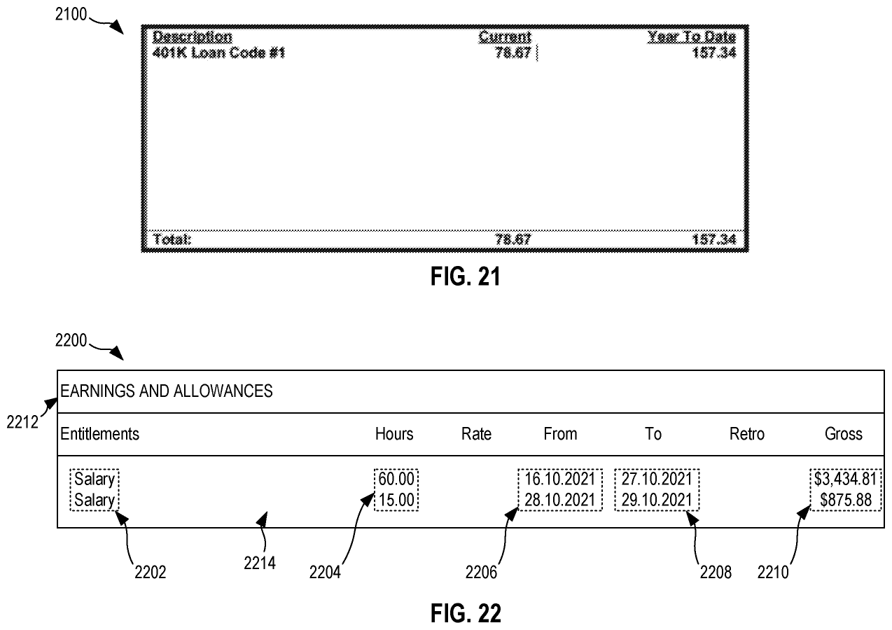

An example of the targeted configuration is shown in FIG. 21. FIG. 21 depicts a table 2100, in accordance with one embodiment. As an option, the present table 2100 may be implemented in conjunction with features from any other embodiment listed herein, such as those described with reference to the other FIGS. Of course, however, such table 2100 and others presented herein may be used in various applications and/or in permutations which may or may not be specifically described in the illustrative embodiments listed herein. Further, the table 2100 presented herein may be used in any desired environment.

A detection algorithm, in some approaches, may be trained and deployed to identify a connected structure that includes a table with a body and header in same cell (single row with underlined headers), as shown in FIG. 21. The detection algorithm may be deployed to identify a cell with an unknown role. For each candidate header (underlined text element), the detection algorithm attempts to find a single-row column body (i.e. a single text element). This single-row column body, in some preferred approaches, must be immediately below (not too far vertically may be defined as not more than the average height of the two text elements in some approaches), and must align (left, right, center). Also, no other text elements can exist in the “header rectangle” (above the column and below or to the side of the underlined text).

The number and type of such labeled text elements is determined and recorded, e.g., data or other. In response to a determination that one labeled text element is of type data is present, this is sufficient. Otherwise at least two labeled other text elements, and their headers (underlined text) must align. If found, a detected table is created, e.g., see FIG. 21, and cell rolls therein may be updated, e.g., TABLE_PART_IMPLIED. In some approaches, an attempt to find and attach a footer cell may be made. Note that techniques for attempting to find and attach a footer cell are described elsewhere herein and may be used in the present embodiment, e.g., see section 3.15.

### 3.24 Attaching Titles to Tables

An example of the targeted configuration is shown in FIG. 22. FIG. 22 depicts a table 2200, in accordance with one embodiment. As an option, the present table 2200 may be implemented in conjunction with features from any other embodiment listed herein, such as those described with reference to the other FIGS. Of course, however, such table 2200 and others presented herein may be used in various applications and/or in permutations which may or may not be specifically described in the illustrative embodiments listed herein. Further, the table 2200 presented herein may be used in any desired environment.

The table 2200 comprises a plurality of text columns, e.g., see first text column 2202, second text column 2204, third text column 2206, fourth text column 2208, and fifth text column 2210. The table 2200 further includes a table header 2212 and a table body 2214.

A detection algorithm, in some approaches, may be trained and deployed to identify a connected structure that includes a table with a title. For example, the detection algorithm may determine, for every table with an adjacent cell above, whether the cell roll is a section heading (SECTION_HEADING). In response to a determination that the cell roll is a section heading, the cell is attached to the table, and the cell role is updated accordingly, e.g., TABLE_TITLE.

### 3.25 Finding Tables: Below Section Headings

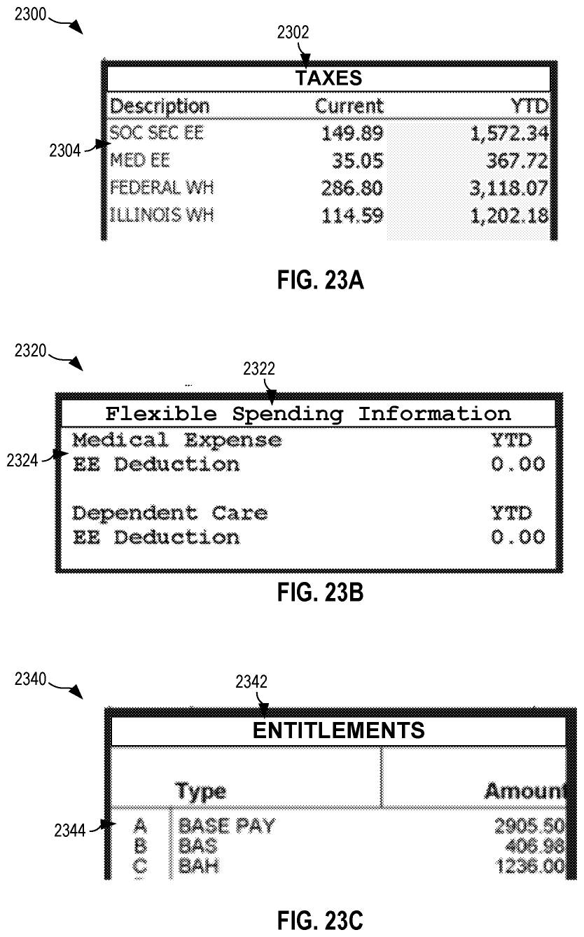

Examples of the targeted configuration are shown in FIGS. 23A-23C. FIGS. 23A-23C depict tables 2300, 2320 and 2340, in accordance with several embodiments. As an option, the present tables 2300, 2320 and 2340 may be implemented in conjunction with features from any other embodiment listed herein, such as those described with reference to the other FIGS. Of course, however, such tables 2300, 2320 and 2340 and others presented herein may be used in various applications and/or in permutations which may or may not be specifically described in the illustrative embodiments listed herein. Further, the tables 2300, 2320 and 2340 presented herein may be used in any desired environment.

Referring first to FIG. 23A, table 2300 includes a title 2302 and implied table parts 2304. Referring next to FIG. 23B, table 2320 includes a title 2322 and implied table parts 2324. Referring next to FIG. 23C, table 2340 includes a title 2342 and implied table parts 2344.

A detection algorithm, in some approaches, may be trained and deployed to identify tables below section headings. For example, the detection algorithm may determine, for every remaining section heading with adjacent cell(s) below and role consistent with header (e.g., not pure data), one or more contiguous cells with the same left/right boundary. If there are multiple cells below, they must be single line.

The detection algorithm may additionally formulate a composite cell by gathering the text elements from the adjacent cell(s) below the section heading cell.

In response to a determination that the composite cell has a single text line, another level of adjacent cell(s) is found and added below (i.e., if composite cell has multiple text lines it is skipped). These text elements are added to the text elements of the composite cell.

The detection algorithm may additionally sort text elements in the composite cell by ascending y-coordinate, and the top two text lines in the composite cell are identified. At least one text element in the second text line from the top must be determined to be type data.

Next, a predetermined header cell criteria is verified to be satisfied, where column header candidates are the text elements in first text line of the composite cell, and column body candidates are the text elements in second text line of the composite cell. Note that the predetermined header cell criteria is described elsewhere herein and may be used in the present embodiment, e.g., see section 3.14. In one optional relatively aggressive enforcement of the identification, a partial match does not qualify, e.g., Aggressive (yes), Partial Match (no). In response to a determination that the criteria above is satisfied, a detected table is created and cell rolls are updated, e.g., Section Heading Cell: TABLE_TITLE and Other Cells: TABLE_PART_IMPLIED. In some approaches, an attempt to find and attach a footer cell may be made. Note that techniques for attempting to find and attach a footer cell are described elsewhere herein and may be used in the present embodiment, e.g., see section 3.15.

### 3.26 Splitting Tables by Title

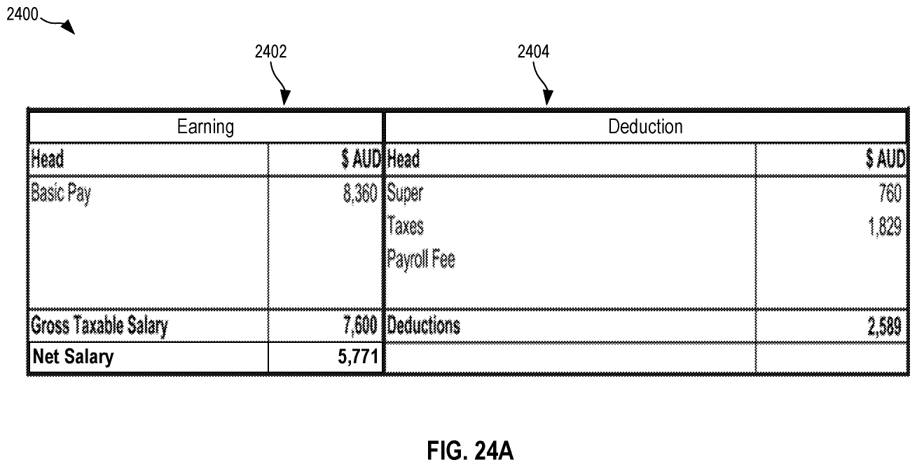

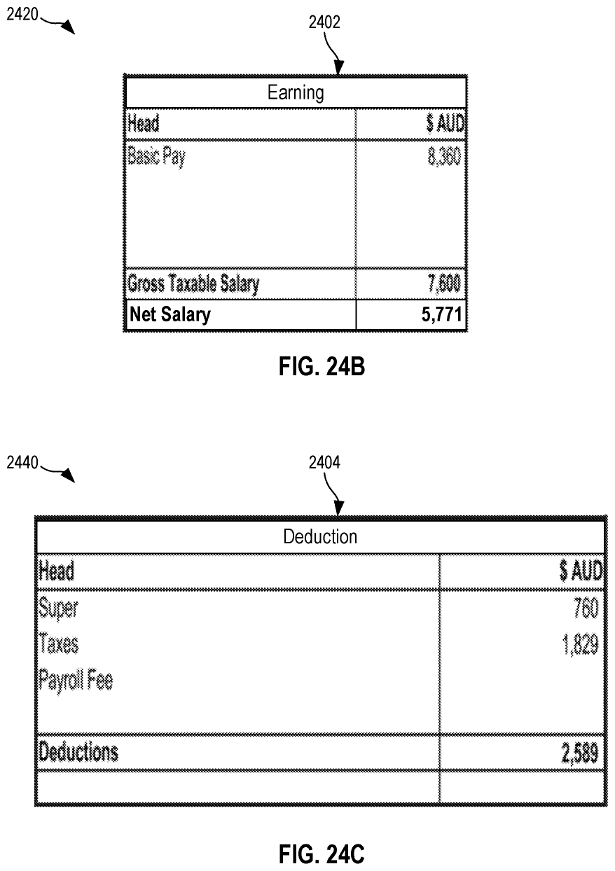

In some documents, connected structures include adjacent tables that would otherwise be detected as a single table, e.g., as in the example shown in FIG. 24A. FIGS. 24A-24C depict connected structures 2400, 2420 and 2440, in accordance with several embodiments. As an option, the present connected structures 2400, 2420 and 2440 may be implemented in conjunction with features from any other embodiment listed herein, such as those described with reference to the other FIGS. Of course, however, such connected structures 2400, 2420 and 2440 and others presented herein may be used in various applications and/or in permutations which may or may not be specifically described in the illustrative embodiments listed herein. Further, the connected structures 2400, 2420 and 2440 presented herein may be used in any desired environment.

Referring first to FIG. 24A, the connected structure 2400 includes a first table 2402 and a second table 2404. A detection algorithm may be used to detect such a connected structure to prevent the connected structure from being otherwise incorrectly interpreted as a single table. For example, the detection algorithm may be caused, e.g., instructed, to analyze every table that does not already have a title and that has at least two adjacent cells of type section heading above (e.g. in FIG. 24A there could be three or more tables). This analysis, in some preferred approaches, comprises find the split point(s) within the tables. The split point(s) is the x-value between section headings. In order to find these point(s), the algorithm considers that there must be a vertical line at this split point(s) that extends the entire height of the table. The table is then split at these split point(s).

In some approaches, the splitting is performed by modifying the connected structure via masking and separating the two or more tables, e.g., thereby creating and storing a plurality of new images within the document that are each a different table, e.g., see FIG. 24B which includes the first table 2402 and FIG. 24C which includes the second table 2404.

### 4. Detecting Sections within Connected Structures

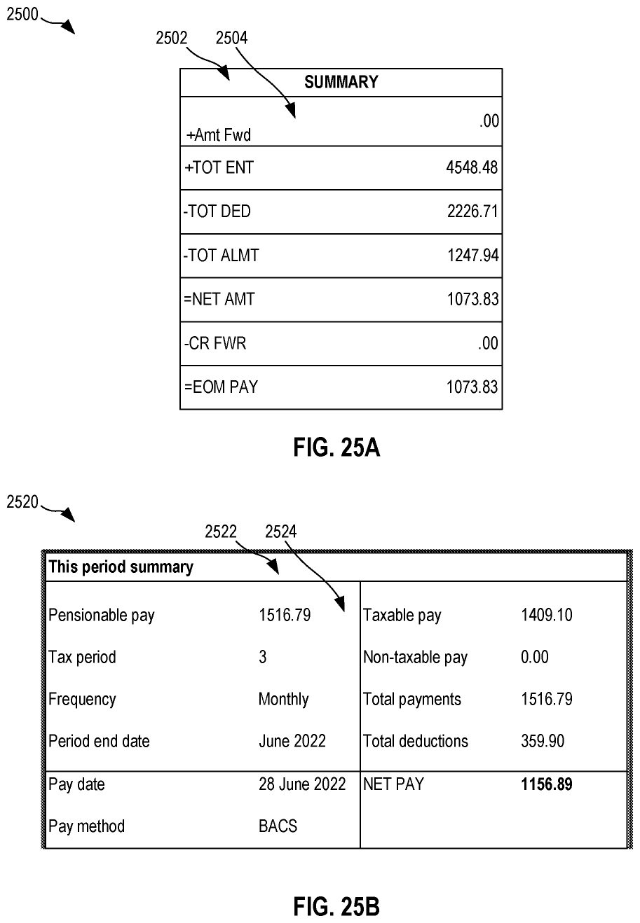

The detection of sections within connected structures is important for reading cell content in correct order in a narrative that is ultimately produced based on the analysis techniques described herein. FIGS. 25A-25B depict connected structures 2500 and 2520, in accordance with several embodiments. As an option, the present connected structures 2500 and 2520 may be implemented in conjunction with features from any other embodiment listed herein, such as those described with reference to the other FIGS. Of course, however, such connected structures 2500 and 2520 and others presented herein may be used in various applications and/or in permutations which may or may not be specifically described in the illustrative embodiments listed herein. Further, the connected structures 2500 and 2520 presented herein may be used in any desired environment.

FIGS. 25A-25B illustrate connected structures with sections. For example, in FIG. 25A, the connected structure 2500 is a section that is a unit with title 2502 and section content 2504 in cells other than the cell that includes the title 2502. Similarly, in FIG. 25B, the connected structure 2520 is a section that is a unit with title 2522 and section content 2524 in cells other than the cell that includes the title 2522.

Depending on the approach, there may be be connected cells on all sides of any given section, and the section should be read as a unit. In particular, if the cells with the section are not grouped, the cells connected to the left and/or right of the section will otherwise cause incorrect sorting. Accordingly, corrective analysis is performed, as described in some approaches below.

### 4.01 Detection Algorithm

In some approaches, a detection algorithm may be trained and deployed to find vertically connected cells that are not yet part of a table and may be the body of a section. These vertically connected cells must be determined to be one of the following roles: unknown, data, key-value, OMR. Furthermore, these vertically connected cells must be adjacent vertically with left or right edges aligned, or, in some approaches, can be just one cell.

For each connected component (candidate section body), a determination may be made as to whether it is the data part of a section. This includes finding the joined rectangle of the cells, finding an unattached section heading cell adjacent above and aligned left and right, and/or disregard section heading cells that are the full width of the connected structure (since this sort correctly anyway). If found, the cell is determined to be a section. For each remaining unattached section heading, a determination is made as to whether there are multiple data components below. This determination, in some preferred approaches, comprise, attempting to identify connected components that were not attached above and that are: adjacent below the section heading, within the horizontal span of the section heading, all have the same bottom, and contiguously span the entire width of the section heading. In response to identifying the connected components described above, the connected components are determined to be a section.

### 5. Detecting and Extracting Tables Outside of Connected Structures

After using the techniques described elsewhere above to detect tables within connected structures, the techniques described herein optionally proceed with detecting and extracting the tables using a table extractor of a type that would become apparent to one of ordinary skill in the art after reading the descriptions herein. In a first pass, in some approaches, the kinds of tables that are targeted may include tables that are outside of any connected structure and/or tables that correspond to an entire connected structure (e.g. as in a typical grid).

### 5.01 Detection and Extraction Algorithm for Extracting Tables

A detection and extraction algorithm may be trained and deployed to exclude from consideration, regions of the document (page) that are identified (during analysis of connected structures) to exclude any connected structure that contains one or more vertically-oriented key-value pairs, as these are not tables. The excluded connected structures may additionally and/or alternatively include key-value lists (whether in connected structure or not).

The exclusion process is performed by removing from the page data structure all text elements and graphical lines within the excluded region(s). In essence, all information in excluded regions is “erased” from the page that is considered by the table extractor. Note that the term erased in some approaches refers to being excluded from a modified version of the page. In some other approaches, the term erased refers to being excluded from or at least temporarily masked or excluded from processing operations performed thereafter for the page.

In some approaches, the operative techniques proceed within executing the table extractor on the modified page (with potentially excluded regions). This may be performed by applying extensions to table extraction algorithms described elsewhere herein and/or in applications incorporated by reference herein. For context, this prevents non-table connected structures from being mistakenly detected as tables (otherwise such misdetections would cause degraded interpretation of a page). These extensions are described below.

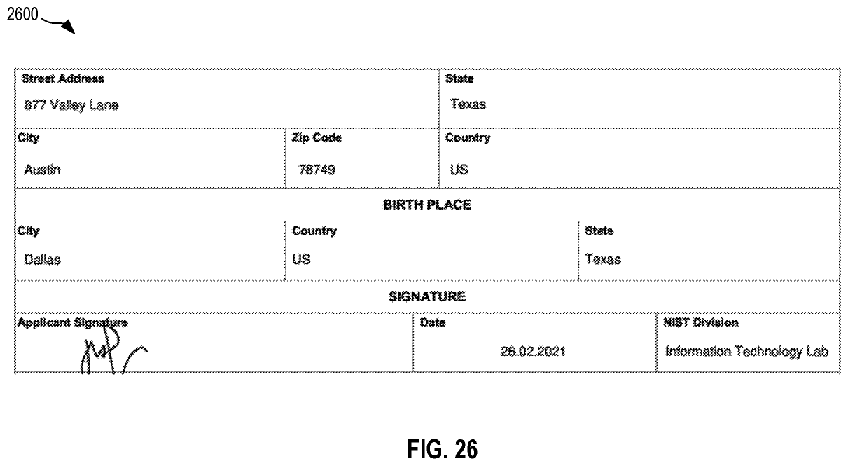

In some approaches, execution of the table extractor applies a rule that initial table columns cannot intersect any excluded region. Furthermore, relatively aggressive table detection is not applied inside boxes that intersect excluded regions. In some approaches, additional protection may be included to ensure that this is not a non-table connected structure. For example, a determination is made as to whether predetermined conditions are present, e.g., there is a vertical line on left or right side of the candidate table (i.e. likely a connected structure) and/or there are significant (i.e. sufficiently long) horizontal and vertical lines inside the candidate table. In response to these conditions being present, no vertical line can end without resuming no more than one horizontal line away (in both directions: up & down). For context, this prevents non-uniform grids (usually containing key-value pairs) from being mistakenly detected as a table. An example of this is illustrated in FIG. 26. FIG. 26 depicts a connected structure 2600, in accordance with one embodiment. As an option, the present connected structure 2600 may be implemented in conjunction with features from any other embodiment listed herein, such as those described with reference to the other FIGS. Of course, however, such connected structure 2600 and others presented herein may be used in various applications and/or in permutations which may or may not be specifically described in the illustrative embodiments listed herein. Further, the connected structure 2600 presented herein may be used in any desired environment.

FIG. 26 depicts a connected structure 2600 that can be identified (using the techniques described above) to be a non-uniform grid (containing key-value pairs) rather than being mistakenly detected as a table. For example, the horizontal line immediately to the left of the word “Texas” ends (in both the upward and downward directions) without ever resuming within the boundary of the table.

Tables that are returned from the table extractor are examined, and only tables that are validated to contain a header (i.e. not lists) are kept. Lists need to be represented differently from tables with headers (which is already being done by other processing referenced herein, e.g., see U.S. patent application Ser. No. 18/763,909). In some approaches, multipage tables may be returned. This is acceptable, for example the header may be present only on the first page of the table and no other headers are present or identified on subsequent pages of the table.

### 6 Extracting Tables within Connected Structures

The operative techniques herein, in some approaches, next include performing a second pass where the tables that were detected inside of a connected structure are extracted, again using the table extractor.

### 6.01 Extraction Algorithm

The table extractor may apply an extraction algorithm that, for every table that was detected within the connected structure, only focuses on a table if the detected table does not intersect any table found in first pass (e.g. often an entire connected structure is a table). For context, these tables were already detected in the first pass performed by the table extractor as described in Section 5 herein. For the tables that the table extractor focuses on, the table extractor is caused, e.g., called via issued instructions, to extract the table, but limit the scope of extraction to the detected table region only, according to regions of a predetermined criteria. These regions of the predetermined criteria specify that all regions outside the detected table region are excluded from consideration. As before, the exclusion process occurs by removing from the page data structure all text elements and graphical lines that lie outside of the detected table region (i.e., as if the page is blank except for the detected table region). Accordingly, there is no true table detection here, and instead just table extraction performed.

### 7 Transforming Tabular Information into a Textual Representation

The following descriptions are illustrative in nature (and what were determined during experimental testing to work best with LLMs). However, any form of representing tabular information in textual format (e.g. HTML, Markdown, etc.) may be used without limiting scope of concepts disclosed herein. The detected and extracted tables may, in some approaches, be added to a narrative by merging items (tables, sections, list items) into an existing hierarchy using the techniques described below. In some approaches, this existing hierarchy comprises a type of hierarchy that results from analysis of a document that would become apparent to one or ordinary skill in the art after reading the descriptions herein. In one approach, the existing hierarchy comprises the “textual representations” of U.S. Pat. No. 12,197,412 which is herein incorporated by reference.

7.01 Merging Sections into the Hierarchy

Various techniques described below detail a sub-process of transforming tabular information into a textual representation by merging sections into the hierarchy.

In the process of analyzing connected structures, certain groups of cells are detected that constitute a section and are preferably treated as a unit. Because the individual cells already exist within the hierarchy, a task that remains includes grouping these cells as a unit. This task is, in some approaches, accomplished by merging into the hierarchy a cell whose boundary corresponds to the boundary of the section. This new cell becomes, in the hierarchy, the parent of all cells that are contained within it. This thereby serves to group those constituent cells for ordering purposes when the narrative is created.

7.02 Merging Tables into the Hierarchy

Various techniques described below detail a sub-process of transforming tabular information into a textual representation by merging tables into the hierarchy.

The tables that were detected and extracted according to the processes described elsewhere above are, in some approaches, merged into the hierarchy using a predetermined process detailed below. This predetermined process is described herein largely by way of example.

For each such table that has been detected and extracted, the predetermined process comprises inserting a cell into the hierarchy corresponding to the boundary of the table. For context, this insertion serves to group the table contents as a single unit when creating the narrative. Importantly, during this process, those parts of the existing hierarchy that intersect with the table rectangle are destroyed. These structures are then replaced by the representation of the table, as described below.

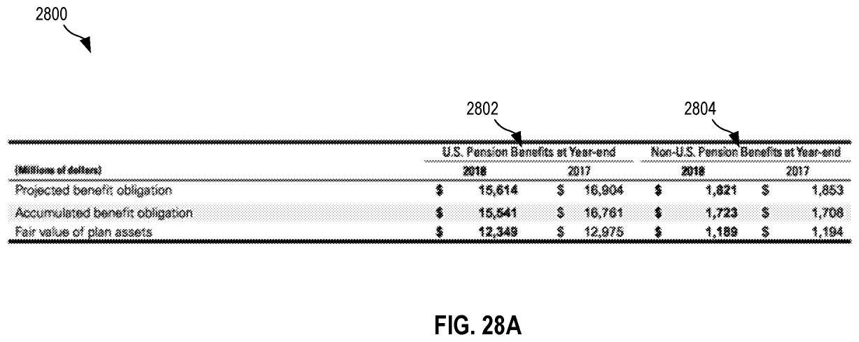

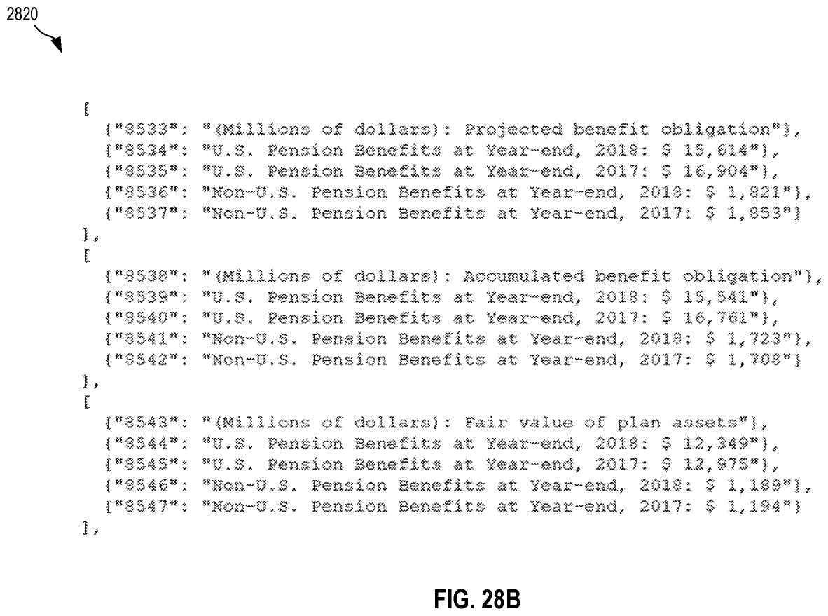

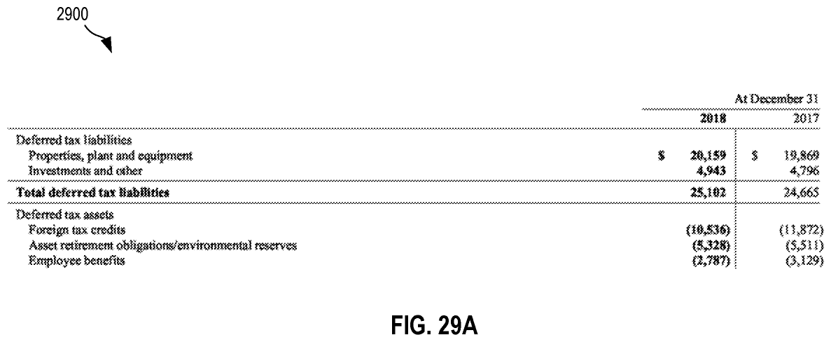

For each data row in the table (i.e. not the header row, not row descriptors), the replacement comprises identifying the rectangle that bounds the location of the row. Furthermore, a textual representation of the row that faithfully represents its meaning is identified. An illustration of this is described below for both simple headers (e.g., see FIGS. 27A-27B) and multi-level headers (e.g., see FIG. 28A-28B).

FIG. 27A depicts a table 2700 that is then represented in FIG. 27B by a generated textual representation 2720 of the table 2700, in accordance with several embodiments. As an option, the present table 2700 and textual representation 2720 may be implemented in conjunction with features from any other embodiment listed herein, such as those described with reference to the other FIGS. Of course, however, such table 2700 and textual representation 2720 and others presented herein may be used in various applications and/or in permutations which may or may not be specifically described in the illustrative embodiments listed herein. Further, the table 2700 and textual representation 2720 presented herein may be used in any desired environment.

Referring first to FIG. 27A, table 2700 is determined to include simple headers. For example, table 2700 is comprised of three data rows 2702, 2704 and 2706. These data rows are translated faithfully into text, in some preferred approaches, by reproducing the header value within a JSON array for each row (which groups the row as a unit), where each object in the JSON array captures the meaning of each entry in the row, e.g., see FIG. 27B.

### 7.03 Multi-Level Headers

FIG. 28A depicts a table 2800 that is then represented in FIG. 28B by a generated textual representation 2820 of the table 2800, in accordance with several embodiments. As an option, the present table 2800 and textual representation 2820 may be implemented in conjunction with features from any other embodiment listed herein, such as those described with reference to the other FIGS. Of course, however, such table 2800 and textual representation 2820 and others presented herein may be used in various applications and/or in permutations which may or may not be specifically described in the illustrative embodiments listed herein. Further, the table 2800 and textual representation 2820 presented herein may be used in any desired environment.

The format described above can also be faithfully represented by serializing the header hierarchy to create a “fully qualified” header value, e.g., using serialization techniques that would become apparent to one of ordinary skill in the art after reading the descriptions herein. For example, table 2800 has multi-level headers, e.g., see header 2802 and header 2804. The table 2800 may be faithfully represented, in some approaches, as the same kind of JSON array for each row (as described above), but the headers are “fully qualified” (separated by commas), e.g., see the generated textual representation 2820 in FIG. 28B.

A text block may then be inserted into the hierarchy corresponding to the location and textual representation of each data row.

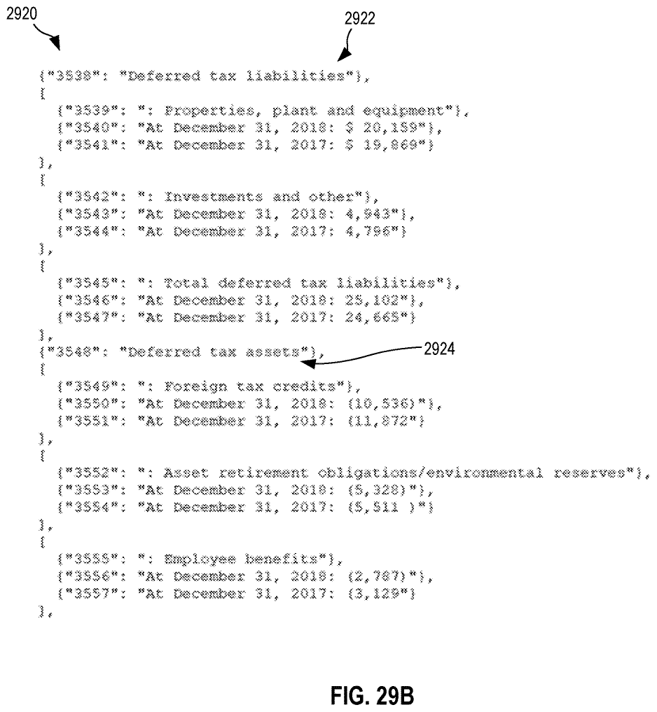

After data rows have been inserted, row descriptors (if any) may be inserted into the hierarchy between data rows according to their location. Certain tables have row descriptors that are important for correctly interpreting the meaning of the row, e.g., as shown in FIGS. 29A-29B.

FIG. 29A depicts a table 2900 that is then represented in FIG. 29B by a generated textual representation 2920 of the table 2900, in accordance with several embodiments. As an option, the present table 2900 and textual representation 2920 may be implemented in conjunction with features from any other embodiment listed herein, such as those described with reference to the other FIGS. Of course, however, such table 2900 and textual representation 2920 and others presented herein may be used in various applications and/or in permutations which may or may not be specifically described in the illustrative embodiments listed herein. Further, the table 2900 and textual representation 2920 presented herein may be used in any desired environment.

Referring first to FIG. 29A, the table includes “Deferred tax liabilities:” and “Deferred tax assets:” that are row descriptors that are inserted into the proper location to faithfully capture the meaning of the data rows. For example, the generated textual representation 2920 in FIG. 29B includes these row descriptors inserted therein, e.g., see descriptor 2922 and descriptor 2924.

7.04 Detecting and Merging List Items into the Hierarchy

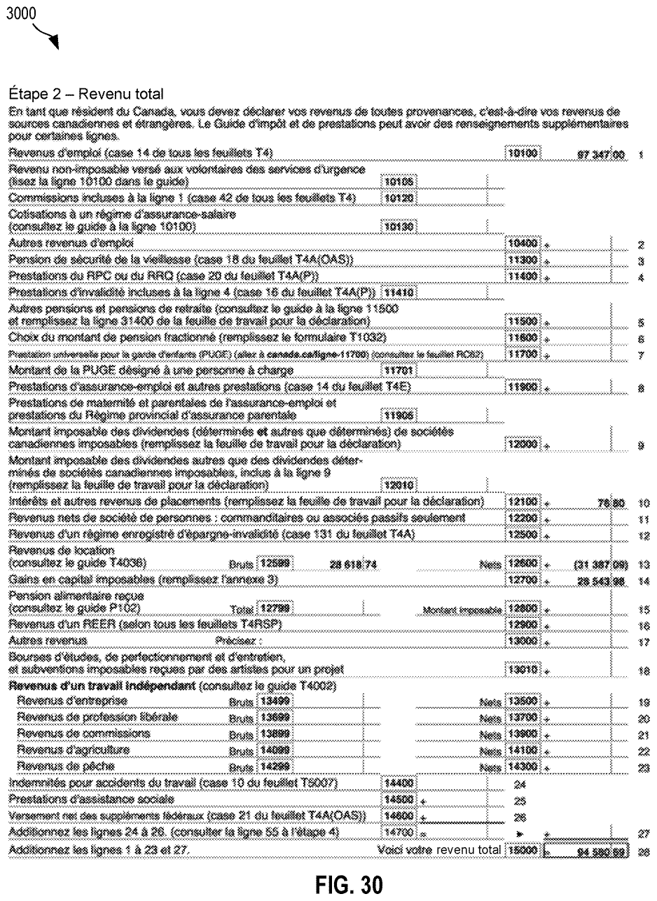

Lists can be viewed as essentially tables without headers. Lists can easily be confused (incorrectly detected by many algorithms) as tables, but they should be interpreted differently from tables in order to faithfully represent the intended meaning of the content. An example of the targeted configuration is shown in list 3000 of FIG. 30. FIG. 30 depicts a list 3000, in accordance with one embodiment. As an option, the present list 3000 may be implemented in conjunction with features from any other embodiment listed herein, such as those described with reference to the other FIGS. Of course, however, such list 3000 and others presented herein may be used in various applications and/or in permutations which may or may not be specifically described in the illustrative embodiments listed herein. Further, the list 3000 presented herein may be used in any desired environment. Note that the list 3000 shares many characteristics with tables. Within list 3000, dollars/cents: cells are not to be interpreted in the usual manner, but rather as an item in a list.

### 7.05 Detection and Merging Algorithm

A detection and merging algorithm may be trained and deployed to detect and merge list items into the hierarchy, where the term “list item” here refers to a single (often enumerated) item in the list, somewhat analogous to a row in a table. In some approaches, the algorithm comprises sorting horizontal lines (tolerantly) top to bottom, left to right. Furthermore, horizontal lines are grouped by y-coordinate. This grouping comprises ignoring horizontally-contained lines (this is possible due to line finding algorithms) and discarding line groups that do not have at least one long line. Line groups that cannot be the bottom of a list item rectangle are identified. To not be discarded, the line groups must be left justified and long, have a line on the left of the group that must be the longest line, must not have large gaps between lines, must not cross any vertical line (even if not intersecting), cannot be the base of a vertical line on the left side of the page (but this is allowed on the right), and cannot intersect any table in y-coordinate.

For remaining (validated) horizontal line groups that are not discarded using the process described above, text blocks that are immediately above any horizontal line in the group are found. These text blocks are within one tolerance vertically and at least half of the text block is underlined horizontally. These rectangles are joined (this is the rectangle of the list item).

A validation is performed to ensure that at least 4 contiguous list item rectangles on the page are found that are aligned left and that are vertically close (within average text height).

In some approaches, split text blocks that are neither wholly inside nor wholly outside of a list item rectangle are processed by decomposing the text block into text blocks that each contain a single text element.

A single composite text block is, in some approaches, created for each list item rectangle. This comprises sorting text blocks that intersect the list item rectangle, e.g., by Y if not intersect in Y and by X if intersect in Y. The value of the composite text block is aggregated, e.g., =v1+“ ” +v2+“ ”+v3 . . . . Then these text blocks are inserted into the hierarchy (which will cause them to be sorted properly). It should be noted that other delineators (e.g. ellipses) may be used in place of horizontal lines without deviating from the scope of the embodiments and approaches described herein.

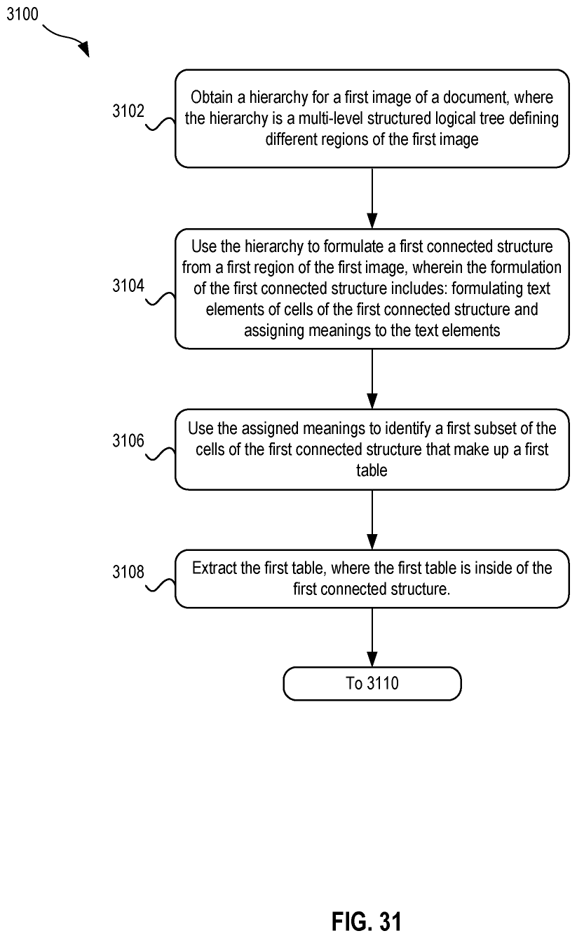

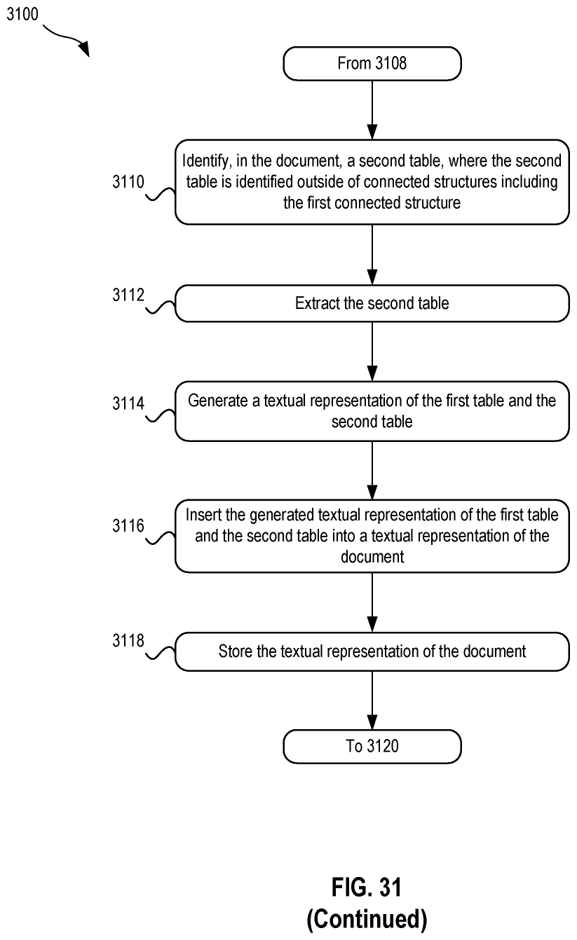

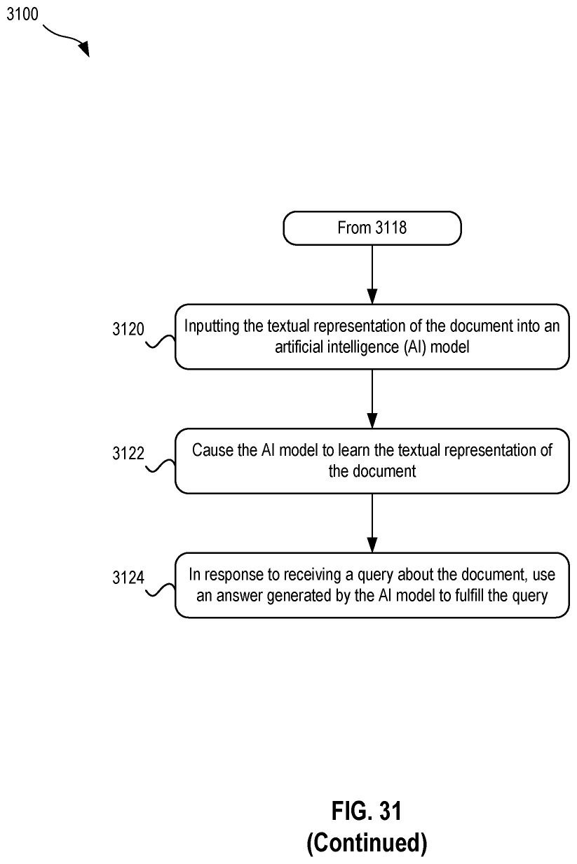

FIG. 31 shows a method 3100, in accordance with one embodiment. As an option, the present method 3100 may be implemented to potentially identify and extract tables inside and/or outside of a connected structure, such as those shown in the other FIGS. described herein. Of course, however, this method 3100 and others presented herein may be used to potentially identify and extract tables inside and/or outside of a connected structure which may or may not be related to the illustrative embodiments listed herein. Further, the methods presented herein may be carried out in any desired environment. Moreover, more or less operations than those shown in FIG. 31 may be included in method 3100, according to various embodiments. It should also be noted that any of the aforementioned features may be used in any of the embodiments described in accordance with the various methods.

Operation 3102 includes obtaining a hierarchy for an image of a document, e.g., a first image. Note that, although a first image is referred to in various descriptions herein, the operative techniques of method 3100 may additionally and/or alternatively be performed with respect to a plurality of images, e.g., the first image, a second image, etc., in some approaches. The hierarchy may, in some approaches, for a single page of the document, e.g., where the first image is one page in a PDF, where the first image is a scanned image, etc. In some other approaches, the hierarchy may be for a plurality of pages of the document, and in this case, a portion of the hierarchy may be used.

For context, in some approaches, the hierarchy is a multi-level structured logical tree defining different regions of the first image. Some different portions within the hierarchy may overlap with one another upon the hierarchy being obtained. This may change upon the hierarchy being analyzed, e.g., analyzed down to distinct elements and structures, as will be described below. The top level (root node) in the hierarchy is preferably an entire page of a document. Further descriptions of such a hierarchy are described elsewhere above.

The hierarchy is, in some approaches, used to formulate a first connected structure from a first region of the first image, e.g., see operation 3104. Note that, in some other approaches, zero connected structures may be formed, e.g., where the first image and/or the document does not include a connected structure. In contrast, in some other approaches, a plurality of connected structures may be formed.

The formulation of the first connected structure, or additional connected structures, in some approaches, includes: formulating text elements of cells of the first connected structure and assigning meanings to the text elements. Of course, formulation of a connected structure may include more or less operations, which are described in detail elsewhere herein, e.g., see 2. Formulate Connected Structures.

The formulating the text elements of the cells of the first connected structure, in some approaches, includes applying an element analyzer function and/or trained module to generate (or modifying) metadata associated with literal textual values within the cells. The generated metadata, in some approaches, annotates (associates, describes, etc.) the literal textual values with predetermined generic types of values (dollar sign, etc.).

The formulation of the first connected structure, in some approaches, further includes performing normalization on the text elements to identify a first portion of the text elements that have known meanings (generic) and a second portion of the text elements that do not have known meanings. For context, the meanings are assigned to the first portion of the text elements, and the meanings are not assigned to the second portion of the text elements. More specifically, not assigning the meanings portion of the text elements actually includes an affirmative assignment of a placeholder of “unknown”, where a value associated with the placeholder is not within the predetermined set of known meanings, e.g., column headers, numberings, etc.

Using the hierarchy to formulate the first connected structure from the first region of the first image may additionally and/or alternatively comprise modifying the hierarchy to define the cells as non-overlapping and independent from one another. For examples, in some approaches, the first region of the first image may include rectangles that are touching and/or rectangles that are not touching. The collection of non-overlapping rectangles (non-overlapping based on rolling of the overlapping portions into one of the other regions) may be identified in the formulation of the first connected structure. Note that each node within the hierarchy uniquely corresponds to a single region within the image. The modified hierarchy is then used to identify the connected cells from the cells of the first connected structure as further described elsewhere herein.

Although, in some approaches, a determination may be made that the connected structure does not include a table, in some descriptions below, a table is identified for purposes of an example, e.g., a first table. For example, method 3100 includes using the assigned meanings to identify a first subset of the cells of the first connected structure that make up a first table within the first connected structure of the first image, e.g., see operation 3106. The first table may be a child of the first connected structure.

Techniques for identifying a table are described elsewhere herein, e.g., see 3 Detecting tables within connected structures and below.

In some approaches, the using the assigned meanings to identify the first subset of the cells of the first connected structure that make up the first table comprises validating the first connected structure. More specifically, in one or more of such approaches, validating the first connected structure comprises determining whether the first connected structure includes less than a predetermined number of text elements that are of at least a predetermined size. In some approaches, the predetermined number of text elements is preferably four. Furthermore, the predetermined size is, in some approaches, preferably significant in size, e.g., sufficiently large as determined by a predetermined string size.

In response to a determination that the first connected structure includes greater than or equal to the predetermined number of text elements, method 3100 includes validating the first connected structure. In some approaches, the first subset of the cells of the first connected structure are, at least in part, determined to make up the first table in response to the first connected structure being validated.

The using the assigned meanings to identify the first subset of the cells of the first connected structure that make up the first table may additionally and/or alternatively comprise validating the first connected structure. For context, in some approaches, validating the first connected structure comprises determining whether the first connected structure includes less than a predetermined number of text lines, e.g., two text lines. The validating may additionally and/or alternatively include, in response to a determination that the first connected structure includes greater than or equal to the predetermined number of text lines, validating the first connected structure. Note that the first subset of the cells of the first connected structure may be, at least in part, determined to make up the first table in response to the first connected structure being validated. In contrast to these approaches, in some approaches, the connected structure is not validated, e.g., in response to a determination that the first connected structure does not include greater than or equal to the predetermined number of text lines. In such a case, the candidate connected structure is determined to not be a connected structure.

The formulation of the first connected structure, in some approaches, additionally and/or alternatively includes identifying connected cells from the cells of the first connected structure, identify roles of the connected cells, and assigning the roles to the connected cells. Based on this, method 3100 may further comprise using the identified roles of the connected cells to identify the first subset of the cells of the first connected structure that make up the first table. In some examples, the roles may include one or more of optical mark recognition (OMR), key value role, and data, although other roles may additionally and/or alternatively be used in some other approaches.

In some further approaches, to identify the first subset of the cells of the first connected structure that make up the first table, method 3100 additionally and/or alternatively comprises using alignment of the text elements to identify the first subset of the cells of the first connected structure that make up the first table. Further techniques for using bold font determinations, alignment of text, and/or other techniques are described elsewhere herein and may be used to identify the first subset of the cells of the first connected structure that make up the first table.

Operation 3108 includes extracting the first table. In some approaches, the first table is inside of the first connected structure. However, a table may, in some approaches, be outside of a connected structure. For example, method 3100, in some approaches, further comprises identifying, in the document, a second table, where the second table is identified outside of connected structures including the first connected structure, e.g., see operation 3110. For example, the second table may reside within the same page of the document but outside of the first connected structure. The second table may be extracted using table extraction techniques described elsewhere herein, e.g., see operation 3112.

With continued reference to the second table, in some approaches, identifying, in the document, the second table comprises: deploying a trained detection and extraction algorithm. The trained detection and extraction algorithm may, in some approaches, be configured to identify and exclude predetermined types of regions of the document from consideration during the identifying of the second table. More specifically, these predetermined types of regions of the document may be identified, during the identification of the first subset of the cells, to be a connected structure that contains one or more vertically-oriented key-value pairs and/or connected structures may additionally and/or alternatively include key-value lists (whether in connected structure or not). A predetermined exclusionary process is, in some approaches, performed to exclude the identified predetermined types of regions of the document from consideration during the identifying of the second table. In one or more of such approaches, the predetermined exclusionary process comprises removing, from a page data structure, all text elements and graphical lines within the identified predetermined types of regions of the document.

Operation 3114 of method 3100 comprises generating a textual representation of the first table. For context, the textual representation may refer to a JSON array of objects, HTML, marked down language, and/or any structural representation that include syntax, in some approaches. The generated textual representation of the first table preferably details semantic meaning about the text elements inside the first table of first connected structure with respect to one another and/or structure of the first table (alignments, number of elements within the same cell, etc.). Further reference may be made to U.S. patent application Ser. No. 18/763,909 for context of textual representations. Operation 3116 includes inserting the generated textual representation of the first table into a textual representation of the document. The textual representation of the document may additionally and/or alternatively be stored, e.g., see operation 3118. In some approaches, the textual representation of the document is stored in memory module dedicated to fulfilling queries that are received.

Operation 3120 includes inputting the textual representation of the document into an artificial intelligence (AI) model. An example of such an AI model includes an LLM. The AI model may be caused, e.g., instructed, to learn the textual representation of the document, e.g., see operation 3122, and thereafter used to fulfill queries. For example, in response to receiving a query about the document, an answer generated by the AI model is used to fulfill the query, e.g., see operation 3124.

In some approaches, the operations of method 3100 and/or other processes and operative techniques described herein may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to evaluate connected structures for generating a textual representation of a table. Initial training may include reward feedback that may, in some approaches, be implemented using a subject matter expert (SME) that generally understands whether the model performs a correct initial estimation. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 3100 may be performed. In some further approaches, the AI model may be a neuromyotonic AI model that may improve performance of computer devices in an infrastructure associated with document analysis by computer processing resources, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from customers of an output of AI models that generate the textual representation. Such an AI model ensures that documents are correctly analyzed, where the scale of such analysis and determinations would not otherwise be feasible for a human to perform. This is because humans are not able to efficiently analyze documents without incorporate processing delays and errors in the document analysis in the process of attempting to do so. Accordingly, management of operations described herein is not able to be achieved by human manual actions.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer-implemented method, comprising:
obtaining a hierarchy for a first image of a document, wherein the hierarchy is a multi-level structured logical tree defining different regions of the first image;
using the hierarchy to formulate a first connected structure from a first region of the first image, wherein the formulation of the first connected structure includes: formulating text elements of cells of the first connected structure and assigning meanings to the text elements; and
using the assigned meanings to identify a first subset of the cells of the first connected structure that make up a first table.

2. The computer-implemented method of claim 1, further comprising: extracting the first table, wherein the first table is inside of the first connected structure.

3. The computer-implemented method of claim 2, further comprising:
identifying, in the document, a second table, wherein the second table is identified outside of connected structures including the first connected structure; and
extracting the second table.

4. The computer-implemented method of claim 3, wherein the identifying, in the document, the second table comprises: deploying a trained detection and extraction algorithm, wherein the trained detection and extraction algorithm is configured to identify and exclude predetermined types of regions of the document from consideration during the identifying of the second table, wherein a predetermined exclusionary process is performed to exclude the identified predetermined types of regions of the document from consideration during the identifying of the second table, wherein the predetermined exclusionary process comprises: removing, from a page data structure, all text elements and graphical lines within the identified predetermined types of regions of the document.

5. The computer-implemented method of claim 1, further comprising: using alignment of the text elements to identify the first subset of the cells of the first connected structure that make up the first table.

6. The computer-implemented method of claim 1, wherein the formulating the text elements of the cells of the first connected structure includes:
applying an element analyzer function to generate metadata associated with literal textual values within the cells, wherein the generated metadata annotates the literal textual values with predetermined generic types of values.

7. The computer-implemented method of claim 6, wherein the formulation of the first connected structure further includes performing normalization on the text elements to identify a first portion of the text elements that have known meanings and a second portion of the text elements that do not have known meanings.

8. The computer-implemented method of claim 7, wherein the meanings are assigned to the first portion of the text elements, wherein the meanings are not assigned to the second portion of the text elements.

9. The computer-implemented method of claim 1, wherein the using the assigned meanings to identify the first subset of the cells of the first connected structure that make up the first table comprises validating the first connected structure, wherein validating the first connected structure comprises:
determining whether the first connected structure includes less than a predetermined number of text elements that are of at least a predetermined size; and
in response to a determination that the first connected structure includes greater than or equal to the predetermined number of text elements, validating the first connected structure,
wherein the first subset of the cells of the first connected structure are, at least in part, determined to make up the first table in response to the first connected structure being validated.

10. The computer-implemented method of claim 1, wherein the using the assigned meanings to identify the first subset of the cells of the first connected structure that make up the first table comprises validating the first connected structure, wherein validating the first connected structure comprises:
determining whether the first connected structure includes less than a predetermined number of text lines; and
in response to a determination that the first connected structure includes greater than or equal to the predetermined number of text lines, validating the first connected structure,
wherein the first subset of the cells of the first connected structure are, at least in part, determined to make up the first table in response to the first connected structure being validated.

11. The computer-implemented method of claim 1, wherein the formulation of the first connected structure includes identifying connected cells from the cells of the first connected structure, identify roles of the connected cells, and assigning the roles to the connected cells, and further comprising: using the identified roles of the connected cells to identify the first subset of the cells of the first connected structure that make up the first table.

12. The computer-implemented method of claim 11, wherein the roles are selected from the group consisting of: optical mark recognition (OMR), key value role, and data.

13. The computer-implemented method of claim 11, wherein the using the hierarchy to formulate the first connected structure from the first region of the first image comprises:
modifying the hierarchy to define the cells as non-overlapping and independent from one another, wherein the modified hierarchy is used to identify the connected cells from the cells of the first connected structure.

14. The computer-implemented method of claim 1, further comprising:
generating a textual representation of the first table;
inserting the generated textual representation of the first table into a textual representation of the document; and
storing the textual representation of the document.

15. The computer-implemented method of claim 14, further comprising:
inputting the textual representation of the document into an artificial intelligence (AI) model; and
causing the AI model to learn the textual representation of the document; and
in response to receiving a query about the document, using an answer generated by the AI model to fulfill the query.

16. A computer program product, comprising a computer-readable storage medium having program code embodied therewith, the program code executable by a computing device to cause the computing device to:
obtain, by the computing device, a hierarchy for a first image of a document, wherein the hierarchy is a multi-level structured logical tree defining different regions of the first image;
use, by the computing device, the hierarchy to formulate a first connected structure from a first region of the first image, wherein the formulation of the first connected structure includes: formulating text elements of cells of the first connected structure and assigning meanings to the text elements; and
use, by the computing device, the assigned meanings to identify a first subset of the cells of the first connected structure that make up a first table.

17. The computer program product of claim 16, the program code executable by the computing device to cause the computing device to: extract, by the computing device, the first table, wherein the first table is inside of the first connected structure.

18. The computer program product of claim 16, the program code executable by the computing device to cause the computing device to: use, by the computing device, alignment of the text elements to identify the first subset of the cells of the first connected structure that make up the first table.

19. The computer program product of claim 16, wherein the formulating the text elements of the cells of the first connected structure includes:
applying an element analyzer function to generate metadata associated with literal textual values within the cells, wherein the generated metadata annotates the literal textual values with predetermined generic types of values.

20. A system, comprising:
a processor; and
logic integrated with and/or executable by the processor, the logic being configured to:
obtain a hierarchy for a first image of a document, wherein the hierarchy is a multi-level structured logical tree defining different regions of the first image;
use the hierarchy to formulate a first connected structure from a first region of the first image, wherein the formulation of the first connected structure includes: formulating text elements of cells of the first connected structure and assigning meanings to the text elements; and
use the assigned meanings to identify a first subset of the cells of the first connected structure that make up a first table.
